(19) United States
(12) Patent Application Publication
(10) Pub. No.: US 2011/0112860 A1
(43) Pub. Date: May 12, 2011

(54) MEDICAL TREATMENT MONITORING SYSTEM AND METHOD

(75) Inventor: Bruce A. KEHR, Potomac, MD (US)

(73) Assignee: INFORMEDIX, INC., Rockville, MD (US)

(21) Appl. No.: 13/008,476

(22) Filed: Jan. 18, 2011

Related U.S. Application Data
(63) Continuation of application No. 10/900,952, filed on Jul. 28, 2004, now abandoned.

(51) Int. Cl. G06Q 50/00; G06Q 10/00

(52) U.S. Cl. 705/2

(57) ABSTRACT

A method and system is provided for monitoring the treatment of one or more patients with one or more medications. A medical treatment plan is defined as a set of data elements stored in a database and representative of a patient configuration file. The data elements are translated into a sequence of prompt and record events, which are communicated to one or more remote monitoring devices. Patient response data, supplied by the patients in response to the events and relating at least in part to a record of the intake of the medication by the patient, are obtained, recorded, and uploaded into the database. The patient response data are correlated with additional data relating to patient health or economic outcomes, for example using statistical analysis and data mining. The correlation can be used to adjust dosing recommendations to improve clinical outcome, reduce side-effects, and eliminate drug interactions.

### CROSS REFERENCE TO RELATED APPLICATIONS

This application claims the benefit of priority under 35 U.S.C. §119(e) from co-pending, commonly owned U.S. provisional patent application, Ser. No. ______, filed on Jul. 28, 2003, and entitled “Method and Apparatus of Providing Adverse Drug Event Monitoring, Reporting, and Treatment, in Clinical Drug Trials.” The entire content of this provisional application is incorporated herein by reference.

### BACKGROUND

Medication is generally regarded as one of the most cost-effective means of medically treating patients. Prior to, and subsequent to, bringing a medication onto the market, the pharmaceutical manufacturer must subject the drug compound to rigorous pre-clinical and clinical tests, to determine its safety, efficacy, and cost. These pre-clinical and clinical tests may be conducted through clinical drug trials, during which the compound is first tested in animals, then in small populations of humans, then in larger populations of humans.

Typically, the safety of the drug, i.e. the incidence and severity of side effects, must first be established. Then preliminary data on effectiveness or efficacy must be established. These early safety and efficacy trials may be conducted in small numbers of human study participants. Subsequently, larger trials may be conducted in order to further define the safety and efficacy profiles for the drug compound at particular doses. These larger trials may, at times, be conducted at multiple different pharmaceutical dosing levels.

The average cost of bringing a new drug to market is about $500,000,000, and takes an average of about seven years. Each day of delay in bringing the drug onto the market costs the manufacturer $1,000,000 to $10,000,000 in lost sales, and reduces the post-market life of the drug's patent.

Once the drug is on the market, post-market surveillance studies may be used to better understand the safety, efficacy, and prevalence of side effects, as well as the interactions of the drug with other drug compounds in combination with the new drug being studied. In addition, new techniques of analyzing the human genome (genomics), human protein structure and function (proteomics), and the physical expression of the genes (phenotyping) are currently being used to help determine the different responses of genetically and phenotypically different populations of patients to pharmaceutical agents.

A number of methods have been used to analyze the effectiveness, cost, and adverse effects of medication. Currently these methods tend to be very labor intensive, and tend to have limited technology that is integrated into the clinical drug trial system. Many of the systems may be paper-based, and tend to rely on retrospective data and written patient diaries.

Recently, various technologies have been introduced into the clinical drug trial process, including electronic devices that may be used to monitor and manage medical treatment regimens and protocols for treating a patient's medical condition and monitoring the patient's outcomes. These devices may communicate one or more of the following: medication schedule and instruction data, medical treatment data, medical education content, patient query data and patient response data, and physiologic data. The devices may include a controller for controlling modes of device operation, controlling access to the memory, controlling the communication of treatment data and patient query data on a display or via voice communications means, receiving and processing patient response data, tracking timing, and providing scheduled medication alarm signals. The devices may also include soft function keys interfaced with the controller. The soft function keys may signal the controller, commanding it to execute different modes of operation of the medical monitoring device. The device may also provide for scheduled medication alarm signals that alert the user concerning prescribed medications to be taken.

What is missing from these known methods and devices for pharmacoeconomic analysis in clinical drug trials, is a medical database that contains real-time data captured from patients. Such real-time data captured from the patients would include data such as: medication compliance for one or more medications taken by the patient, patient answers to health status and quality-of-life questionnaires, patient physiologic data, and patient laboratory data.

These known methods and devices also lack the ability to combine such patient monitoring data with other database data such as genomic, proteomic, phenotypic, economic, and other healthcare related data, for further data analysis. In particular, the known methods lack and devices lack the ability to combine the patient monitoring data with genomic, proteomic, and physiologic data, to predict the responses of subpopulations of patients to a given drug or combination of drugs, in different doses and combinations, based upon the specific genetic and physical attributes of these subpopulations.

Further, the known methods and devices also are not able to perform statistical analyses and data mining for part or all of the data, and for correlating patient medication dosing patterns of one or more drugs ingested by the patient, with various other measures of clinical and economic outcomes of the patient.

### SUMMARY

A method and system are described for monitoring the treatment of one or more patients with one or more medications, so that the effectiveness, cost, and any adverse effects of the medication can be analyzed. A medical treatment plan is defined as a plurality of data elements that are stored in a database linked to one or more remote monitoring devices. The plurality of data elements are representative of one or more patient configuration files. The data elements are translated into a sequence of prompt and record events, using business logic rules.

The sequence of prompt and record events are communicated to one or more remote monitoring devices. Patient response data are supplied by the patients, in response to the sequence of events delivered to the remote monitoring devices. The patient response data relate at least in part to a record of the intake of the medication by the patient. The patient response data are recorded by the remote monitoring device, and uploaded into the database. The database may update one ore more patient configuration files, in response to receipt of the patient response data.

The patient response data is analyzed and mined. The patient response data may be combined with additional data relating to patient health or economic outcomes for further analysis, for example statistical analysis and data mining. The patient response data is correlated with the additional data. The correlation can be used to adjust dosing recommendations to improve clinical outcome, reduce side-effects, and eliminate drug interactions. The correlation obtained from statistical analysis can also be used to predict the responses of subpopulations of patients to the medication, either alone or in combination with other drugs and in different doses, based upon the particular genetic and physical attributes of these subpopulations.

### BRIEF DESCRIPTION OF THE DRAWINGS

FIG. 1 illustrates a schematic flow chart that illustrates a method of monitoring the effect of a medication, in accordance with one embodiment.

FIG. 2 schematically illustrates a system for monitoring medication treatment, in accordance with one embodiment.

FIG. 3 illustrates a LOGIN Screen, in an exemplary data structure in accordance with one embodiment.

FIG. 4A illustrates a Main Menu screen, in an exemplary database structure in accordance with one embodiment.

FIG. 4B illustrates a Patients screen, in an exemplary database structure in accordance with one embodiment.

FIG. 4C illustrates how the Patient Information form becomes populated with the patient information for a particular patient.

FIG. 4D illustrates how new patients are added, in an exemplary database structure in accordance with one embodiment.

FIG. 4E illustrates configuration management, in an exemplary database structure in accordance with one embodiment.

FIG. 4F illustrates how the medication dose is specified, and other medication educational content displayed,

FIG. 5A illustrates how the Questionnaires are accessed, in an exemplary database structure in accordance with one embodiment.

FIG. 5B illustrates the entering of a Personal Questionnaire for a particular configuration, in an exemplary database structure in accordance with one embodiment.

FIG. 5C illustrates a Personal Questionnaire, in an exemplary database structure in accordance with one embodiment.

FIGS. 6A-6C illustrate public questionnaires, in an exemplary database structure in accordance with one embodiment.

FIGS. 7A-7B illustrate sounds and alarms, in an exemplary database structure in accordance with one embodiment.

FIG. 8 illustrates the creation of physician and case worker files, in an exemplary database structure in accordance with one embodiment.

FIGS. 9A-9B illustrates the generation of configuration files, in an exemplary database structure in accordance with one embodiment.

FIGS. 10A and 10B illustrate event reporting and event details, in an exemplary database structure in accordance with one embodiment.

FIG. 11 illustrates the compliance screen, in an exemplary database structure in accordance with one embodiment.

FIGS. 12A-12C illustrate the administration and the customer screens, in an exemplary database structure in accordance with one embodiment.

FIGS. 13A-13B illustrate the “Security” screen and the “Sponsors” screen, in an exemplary database structure in accordance with one embodiment.

### DETAILED DESCRIPTION

A method and system are described for rapidly monitoring and reporting the effects of pharmaceutical agents upon a patient, or populations of patients, who may be participating in clinical drug trials or disease management programs. The method and system described below have application in clinical drug trials and outcomes research protocols, which are designed to determine the therapeutic effects, side effects, adverse drug events, and costs of new pharmaceutical agents, and agents that are already on the market. The method and system described below also have applications when specific drugs are target for specific patient populations at specific doses. In these applications, the method and system described below can optimize patient outcomes, while minimizing side effects, adverse drug events, and costs.

The methods and techniques described below can be implemented by one or more computer systems, which may be selectively activated or reconfigured by one or more computer programs stored in the computer system. Such computer programs may be stored in a computer readable storage medium.

A computer-readable medium is any article of manufacture that contains data that can be read by a computer or a carrier wave signal carrying data that can be read by a computer. The computer-readable medium may include magnetic media, such as floppy disks, flexible disks, hard disks, reel-to-reel tape, cartridge tape, cassette tape, read-only memories (ROMs), random access memories (RAMs), and magnetic cards; optical media, such as optical disks, CD-ROMs, writable compact disk, EPROMs, EEPROMs, and optical cards; magneto-optical media, such as magnetic-optical disks; paper media, such as punched cards and paper tape; or any type of media suitable for storing electronic instructions. Such computer readable storage medium is typically coupled to a computer system bus. The computer-readable instructions used to operate the trial performance monitoring system described below may also be distributed on a carrier wave signal received through a network, wireless network, or modem, including radio-frequency signals and infrared signals.

Some portions of the detailed descriptions that follow are presented in terms of algorithms and of operations on data bits within a computer memory. An algorithm is conceived to be a self-consistent sequence of acts leading to a desired result. These acts require physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as values, data, data elements, bits, elements, symbols, characters, numbers, or the like. All of these and similar terms are to be associated with the appropriate physical quantities and are merely convenient labels applied to these quantities.

Unless specifically stated otherwise, discussions that utilize terms such as “processing” or “computing” or “calculating” or “determining” or “displaying” or the like, refer to the actions and processes of the computer system, or a similar electronic computing device. The computer system manipulates and transforms data, represented as physical or electronic quantities within the computer system's registers and memories, into other data similarly represented as physical quantities within the computer system's memories or registers, or within other such information storage, transmission or display devices.

The methods and systems described below may be implemented using computer software. Computer software may be referred to using different terms, for example a program, a procedure, or an application. If written in a programming language conforming to a recognized standard, sequences of instructions designed to implement these methods and systems can be compiled for execution on a variety of hardware platforms and for interface to a variety of operating systems. Also, these methods and systems are not described with reference to any particular programming language. It will be appreciated that a variety of programming languages may be used to implement the teachings of the invention as described herein. Furthermore, it is common in the art to speak of software, in one form or another, as taking an action or causing a result. Such expressions are merely a shorthand way of saying that execution of the software by a computer causes one or more processors in the computer to perform an action or produce a result.

The methods and techniques described below are typically implemented in distributed computing environments, where certain tasks are performed by remote processing devices that are linked through a communications network. The algorithms and displays presented herein are not inherently related to any particular computer or other apparatus, however. Various general purpose systems may be used with programs that are designed in accordance with the teachings below, or it may prove convenient to construct a more specialized apparatus to perform the requisite methods and techniques. For example, any of the methods described below can be implemented in hard-wired circuitry, or by programming a general purpose processor, or by any combination of hardware and software. One of skill in the art will appreciate that a wide variety of computer system configurations may be used to implement the methods and techniques described below, including hand-held devices, multiprocessor systems, microprocessor-based or programmable consumer electronics, network PCs, minicomputers, mainframe computers, and the like.

The methods described below are typically implemented using computer software. If written in a programming language conforming to a recognized standard, sequences of instructions designed to implement the methods can be compiled for execution on a variety of hardware platforms and for interface to a variety of operating systems. In addition, the methods and systems discussed below are not described with reference to any particular programming language. It will be appreciated that a variety of programming languages may be used to implement the teachings as described herein.

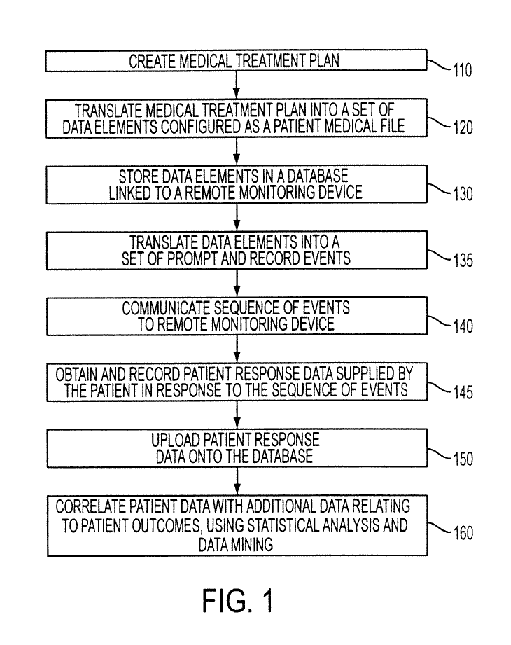

FIG. 1 illustrates a schematic flow chart that illustrates a method of monitoring the effect of a medication, in accordance with one embodiment. Specifically, the method illustrated in the flow chart can monitor the effectiveness, performance, costs, and possible adverse events, of a medication. In overview, the method 100 is directed to monitoring the effects of a medication on one or more patients, by creating medical databases that contain data elements that define a medical treatment plan or a clinical protocol for a patient, and linking them with real-time patient monitoring devices that obtain and record patient data supplied by the patient in response to receipt of the data elements. The patient data derived in this manner can be analyzed and mined, or combined with other types of data (e.g., genetic, proteomic, or phenotypic) for further analysis, in order to determine the relationship between variables such as drug doses, patient outcomes, and costs of treatment.

In step 110, a medical treatment plan is created to treat one or more patients with a medication. Individual patient medical treatment plans may be remotely created, modified, or viewed in a database that is linked over a communications network to one or more remote medical monitoring devices. These devices are medical monitoring devices configured for real-time use by, and interaction with, the patients. Although the following description will focus a single patient, for convenience, it should be understood the medical treatment plan may treat a plurality of patients, or a plurality of populations of patients. In one embodiment, two or more medical monitoring devices may be used by a single patient.

In step 120, the medical treatment plan is translated into a set of data elements configured as a patient medical file. These data elements are stored in step 130 in the database that is linked to the remote monitoring devices. Once the caregivers populate the data fields in the database by selecting a combination of data elements for the medical treatment plan from a number of possible data elements, they enter the data elements into the data fields of the database.

In step 135, these data elements are translated by business logical rules into a sequence of prompt and record events, i.e. into a sequence of time-and-event-driven, graphic and/or auditory, real-time communications delivered in real-time in step 140 to the patient or caregiver via the remote medical monitoring devices. These remote monitoring devices may include a display, and a controller that causes the event-driven, real-time communications to be displayed on the display.

The database may convert the populated data fields in the database into configuration files that are downloaded into the individual patient's monitoring devices, and stored in their memories. In the alternative, the database may sequentially transmit the real-time prompt-and-record events directly into the patient devices. This method results in patient management protocols that can be instantaneously updated. Through this method, the caregivers need not develop new software each time they want to change the database or patient protocols; and the patient needn't worry that a particular monitor, unsuited for a particular lifestyle situation, need be used.

As one illustrative example, a complex treatment regimen for heart failure patients of a specific age, gender, race, and phenotype may be created, and converted into a series of prompt-and-record events to be delivered to multiple monitoring devices used by patients. Heart failure patients may typically require the following data elements in their medical treatment plan, with information about each data element to be communicated at a particular time: a medication regimen comprised of a beta-blocker, ACE inhibitor, diuretic, and Digoxin; dosing instructions for each medication; a description of each medication and rationale for taking the medication; what the medication looks like along with its color; daily measures of weight, blood pressure, pulse, and blood oxygen levels; a salt restricted, low fat, low calorie diet; an exercise program tailored to their specific level of heart failure; questionnaires that assess their shortness of breath, chest pain, energy level, and swelling of the legs; information updates about new drugs used to treat the condition; information about when to call the doctor with specific complaints or side effects or adverse drug reactions; and other information.

In step 145, the patient interacts with the remote devices to supply, in response to receipt of the prompt and record events, patient data that relate at least in part to a record of the intake by the patient of the medication being monitored, i.e. to whether the patient is properly following the medical treatment plan. For example, the real-time data captured from the patients may include, but is not limited to: medication compliance for one or more medications taken by the patient, patient answers to health status and quality-of-life questionnaires, patient physiologic data (e.g. blood pressure, EKG, pO2, pulse rate, weight, pulmonary function, etc.), and patient laboratory data (e.g. measured values of blood tests, serum tests, urine tests, and other laboratory tests). The captured patient data is recorded by the remote monitoring devices, which may record the patient interactions in real time.

In step 150, the patient data captured and recorded in step 145 is uploaded to the database. The recorded data may be communicated to the database in real-time, or via store-and-forward means. The database may capture information from each of a plurality of remote monitoring devices. The database may update and synchronize the information presented to all of the plurality of monitors.

In step 160, the patient data is correlated with additional data relating to a variety of patient outcomes. In this step, the real-time data captured from the patients may be combined with other database data, such as genomic, proteomic, phenotypic, economic, and other healthcare related data, for further data analysis. The combined data may be subjected to statistical analysis and data mining. Such a statistical analysis may include, for example, correlating patient medication dosing patterns of one or more drugs ingested by the patient, with various other measures of clinical and economic outcomes of the patients. In this way, the relationship between drug doses, patient outcomes, and costs of treatment can be determined.

In one embodiment, the combination of the patient monitoring data with the additional data (i.e. genomic, proteomic, and physiologic data) for analysis and data mining purposes enables the responses of subpopulations of patients to a given drug or combination of drugs to be predicted, in different doses and combinations, based upon the specific genetic and physical attributes of these subpopulations.

In one embodiment, the knowledge gained from such data analysis and mining can be used to, inter alfa: adjust the dosing recommendations of one or more medications to improve clinical outcome, reduce the frequency of side-effects, reduce the severity of side-effects, eliminate adverse drug events, reduce or eliminate drug-interactions, and determine the most cost-effective means of using drugs to improve the health of specific populations of patients.

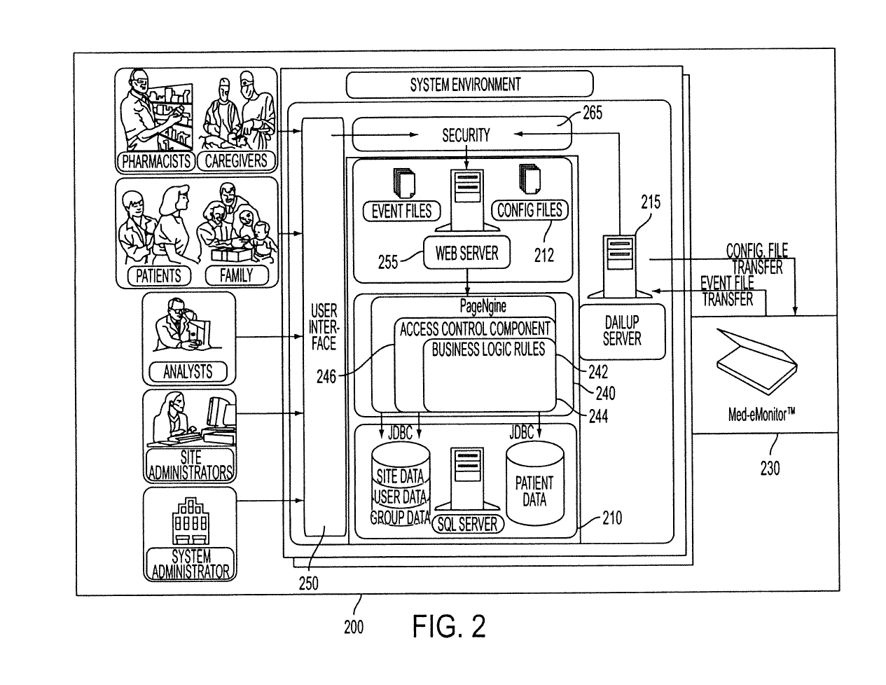

FIG. 2 schematically illustrates a diagram of a computer system 200 for monitoring the effect of a medication, in accordance with one embodiment. While representative of an illustrative example, the system 200 shown in FIG. 2 is not meant in any way to be limiting by its descriptiveness, and different embodiments may include different components for implementing the techniques described in this patent. In overview, the system is based on an Internet-enabled database, a networked communications system, and one or more medical monitoring and laboratory testing devices. Specifically, the system 200 illustrated in FIG. 2 includes: a database 210 linked through a dialup server 215 to a remote monitoring device 230 configured for use by the patient; a user interface 250; and a database controller 240 for the database 210. While only a single remote monitoring device 230 is shown in the embodiment illustrated in FIG. 2, a plurality of remote monitoring devices 230 may be used. In one embodiment, two or more remote monitoring devices 230 may be available for use by a single patient.

The database 210 may be a standard ODBC (object-oriented database compliant database), and is preferably an Internet-enabled database. The database 210 is configured to store therein a plurality of data elements representative of a medical treatment plan for treating the patient with the medication. Individual patient medical treatment plans may be remotely created, modified, or viewed in the database. In the illustrated embodiment, the medical treatment plan is configured as a patient medical file, and stored as configuration files 244. The database software may be any known and functional database software, for example provided by Oracle or Microsoft.

The user interface 250 allows one or more users to interact with the database 210, for example by connecting through a Web server 255. Exemplary users who may access the database are indicated in FIG. 2, and include pharmacists, caregivers, patients, patient families, analysts, site administrators, and a system administrator.

The database controller 240 controls the database 210, as well as controlling the communications through the Web server 255 and the dialup server 215. As illustrated, the controller 240 includes an access control component 242, which controls access to the database, and a PageNgine 246. As seen from FIG. 2, the controller 240 has stored therein business logic rules 244, which allow a computer program (also stored in the controller 240), when executed by the controller 240, to transform the data elements (which may be stored as configuration files 244) into a sequence of prompt and record events. The computer program is also executable by the database controller 240 to cause the prompt and record events to be communicated to the remote monitoring device 235, in the form of real-time communications to the patient. The computer program is also executable by the database controller 240 to receive from the remote monitoring device 230 patient response data, which are supplied by the patient in response to the prompt and record events.

The database application, in this case provided in a Microsoft SQL Server 7 database, can be converted into configuration files that are downloaded via modem, cable, infra-red, laser, computer disk, or wireless means into the multiple patient monitors used by each individual patient. The files are translated into routines that convert the medical protocol structure into a series of prompt and record events. In this way the patients get the benefit of treatment protocols on a real-time basis regardless of which monitor they use at a particular time. The business logic rules that enable the database controller 240 to transform the configuration files stored in the database into prompt and record events may be any known and functional systems, for example the system provided by Affymatrix Corporation.

Once the caregivers populate the data fields in the database by selecting a combination of data elements for the medical treatment plan from an infinite number of possible data elements, they enter the data elements into fields of the database. The database converts these fields into configuration files that are downloaded into the individual patient's devices or monitors and stored in their memories. In the alternative, the database may sequentially transmit the real-time prompt-and-record events directly into the patient devices. This method results in patient management protocols that can be instantaneously updated. Through this method, the caregivers need not develop new software each time they want to change the database or patient protocols; and the patient needn't worry that a particular monitor, unsuited for a particular lifestyle situation, need be used.

The business logic rules 244 and the access control component 242 in the database controller 240 determine the synchronization of data between the database and the multiple remote medical monitors that may be used by each patient. The software that synchronizes the database 210 with the remote patient monitoring devices 230 may be provided by any known and functional system, such as Aether Corporation's ScoutSync technology. The business logic rules and the access control component also determine a role-based assignment for each user of the database 210, according to the rules enumerated in a Use Case Scenarios, attached to this patent as Appendix II. The rules enumerated determine who has access to the database 210, whether they can write to the database and if so what they can write, and whether they can write and read, or have read-only privileges. The level of read-only privilege is also defined by the Use Case Scenarios in Appendix II.

The system 200 may also include a security module 265, which performs a security check on the communications through the user interface from the users of the database, as well as on the communications from the remote monitoring device through the dialup server.

The computer program is also executable by the database controller 240 to analyze and mine the patient data, and to combine the patient data with additional data, for further analysis of the combined data. The additional data may include, for example, genomic, proteomic, phenotypic, economic, and other healthcare related data. The further analysis may include, inter alia, statistical analysis and data mining. The statistical analysis and data mining may include, inter alia, the method of correlating patient medication dosing patterns of one or more drugs ingested by the patient, with various other measures of clinical and economic outcomes of the patient. The medical data statistical analysis and data mining functions can be performed by any known and available functional system, such as the system provided by Medical Internet Solutions, Inc.

The data elements that comprise the medical data entered into the database may relate to one or more of the following: instructions or medical educational content about specific medication; medication dosage; patient physiological measurement, for example weight, blood pressure, pulse rate, glucose level, any antigen level, pH, pO₂, temperature, EKG rhythm, pO2 saturation of the blood, hormone level; cell surface receptors; serum proteins; DNA data; protein data; any psychological measurement, for example the score based upon standardized or non-standardized tests measuring anxiety, stress, anger, suicidal tendencies, schizophrenic relapse, rapid cycling bipolar relapse or confusion.

The data elements may further relate to one or more of the following: medical education content related to any disease state or medical condition, for example congestive heart failure, hypertension, angina, circulatory inadequacy or other disease condition of the cardiopulmonary and circulatory systems, specific organ failure, dysfunction of an organ or system or transplanted organ such as asthma for the lungs, kidney failure for the kidney, arteriosclerosis or atherosclerosis of the heart, and transplantation of lung, kidney or heart; class of pathogen, or a specific pathogen. Further, the instructions or content may be based upon viral infection, or upon a specific viral disease such as HIV/AIDS, hepatitis A,B,C,D,E or G.

Similarly, the instructions or content comprising the data elements may be based upon a bacterial disease agent, for example tuberculosis, malaria, cholera and meningitis; a specific microbial agent such as a virus, bacteria, mycotic infection and parasitic infection; or may be based upon the type of disease or pathology involved or the physiological system effected; for example cancer, autoimmune disease, muscular-skeletal system, or pathology of the hematopoetic, circulatory, reproductive, dermatologic, digestive, endocrine or nervous systems.

In an embodiment in which a DNA profile is detected, the DNA profile detection may be provided by any known and available DNA Chip System, such as that provided by Affymatrix Corporation. In an embodiment in which serum protein and cell surface receptor data are stored in the database, the protein and cell surface receptor data may be provided by any Protein Chip System, such as that provided by Affymatrix Corporation.

Any remote monitoring device 230 capable of communicating by modem, fax, phone line or wireless means may be used to collect the patient data that is communicated to the database for storage and for display. For example, the remote monitoring device 230 may be any one of the following: Personal Digital Assistant such as Palm Pilot®, cellular telephone, interactive pager, interactive television, or proprietary device such as the Med-eMonitor™. Among the monitoring devices that may be used is the Medi-Monitor® described in PCT patent application WO98/38909, incorporated herein by reference in its entirety.

As seen from FIG. 2, the data elements, stored in the database as configuration files 244, can be transmitted to the remote monitoring device 230 from the database to the monitoring device 230 via the dialup server 215. The event files, containing the patient response data provided by the patient in response to the prompt and record events, can be transferred or uploaded from the remote monitoring device 230 to the database via the dialup server.

In one embodiment, the remote monitoring device 230 may include a controller, a memory, and a display, where the controller is configured to control access to the memory, and to control the display of prompt messages on the display. The remote monitoring device 230 may also include a receiver/transmitter for receiving and transmitting data. The controller in the remote monitoring device 230 may be programmed or otherwise configured to execute, upon receipt of the prompt and record events from the database, an interaction between the patient and the monitoring device. During this interaction, the prompt and record events are displayed on the display of the monitoring device, and the patient provides patient response data relating to whether the patient is properly following the treatment plan. The patient data relates at least in part to a record of the intake by the patient of the medication. The controller is also configured to record and store the patient response data in the memory of the monitoring device, and to upload the recorded data onto the database 210.

Alarm-based medication events, educational content messages, alarm-based treatment instructions, questionnaires, and any other elements contained in the medical treatment plan or protocol can be delivered over time and space to all of the remote monitoring devices in a synchronized fashion. As the patient responds to a particular device by inputting data into the device, the database synchronously updates its patient file and the treatment regimen.

The events that are then prompted and recorded can be organized and managed in an event log attached to this patent as Appendix I, which corresponds with the appropriate fields of the database that is prepared to accept the events from the event log. This event log listing is by no means meant to be limiting, as the event log could also include: specific medication; medication dosage; patient physiological measurement, for example weight, blood pressure, pulse rate, glucose level, any antigen level, pH, pO₂, temperature, EKG rhythm, pO2 saturation of the blood, hormone level; any psychological measurement, for example the score based upon standardized or non-standardized tests measuring anxiety, stress, anger, suicidal tendencies, schizophrenic relapse, rapid cycling bipolar relapse or confusion; medical education content related to any disease state or medical condition, for example congestive heart failure, hypertension, angina, circulatory inadequacy or other disease condition of the cardiopulmonary and circulatory systems, specific organ failure, dysfunction of an organ or system or transplanted organ such as asthma for the lungs, kidney failure for the kidney, arteriosclerosis or atherosclerosis of the heart, and transplantation of lung, kidney or heart; class of pathogen, or a specific pathogen; for example instructions or content may be based upon viral infection, or upon a specific viral disease such as HIV/AIDS, hepatitis A,B,C,D,E or G. The instructions or content comprising the data elements may be based upon a bacterial disease agent, for example tuberculosis, malaria, cholera and meningitis; a specific microbial agent such as a virus, bacteria, mycotic infection and parasitic infection; or may be based upon the type of disease or pathology involved or the physiological system effected; for example cancer, autoimmune disease, muscular-skeletal system, or pathology of the hematopoetic, circulatory, reproductive, dermatologic, digestive, endocrine or nervous systems.

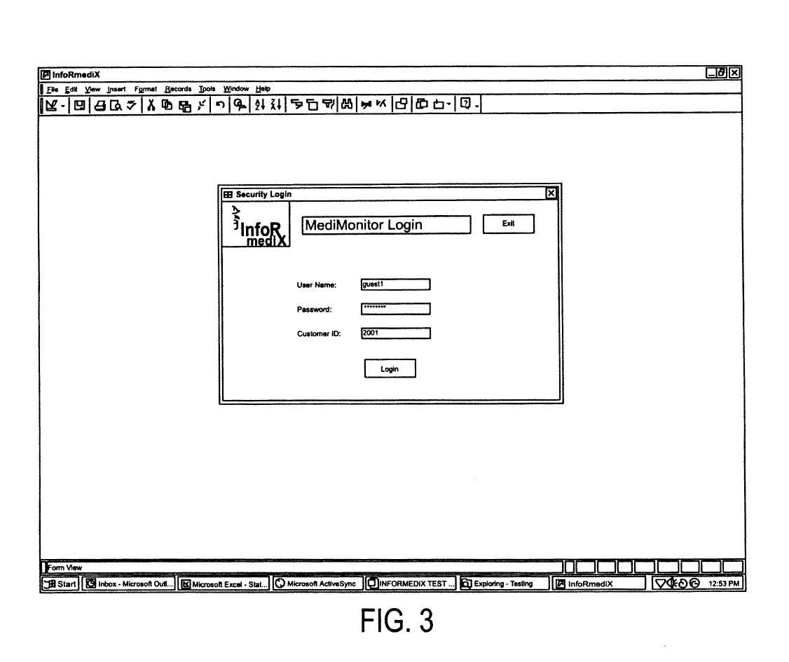

FIGS. 3-13B illustrate in more detail how the method and system described above can be implemented, in accordance with one embodiment. In particular, a database application written in Microsoft SQL Server 7 is illustrated, describing inter alia, the following aspects: the generation of new patient configurations; entering and editing questionnaires for one or more configurations; creating physicians and case workers; generating and reporting events. The example discussed in conjunction with FIGS. 3-13B is written in Microsoft SQL Server 7. While illustrative, this example should in no way be construed as limiting the invention.

FIG. 3 illustrates a LOGIN screen. User Login is verified through this first screen. In the exemplary embodiment, the user is prompted for a User Name, password and Customer ID. If the appropriate information is entered, the user is taken to the Main Menu. If not, a message box appears with the text “Invalid User Name or Password.” The data fields appearing on the LOGIN screen are fields for User Name, Password, and Customer ID. In the illustrated example, the following information was entered: User Name (Guest1); Password: (Guest1) and Customer ID (2001).

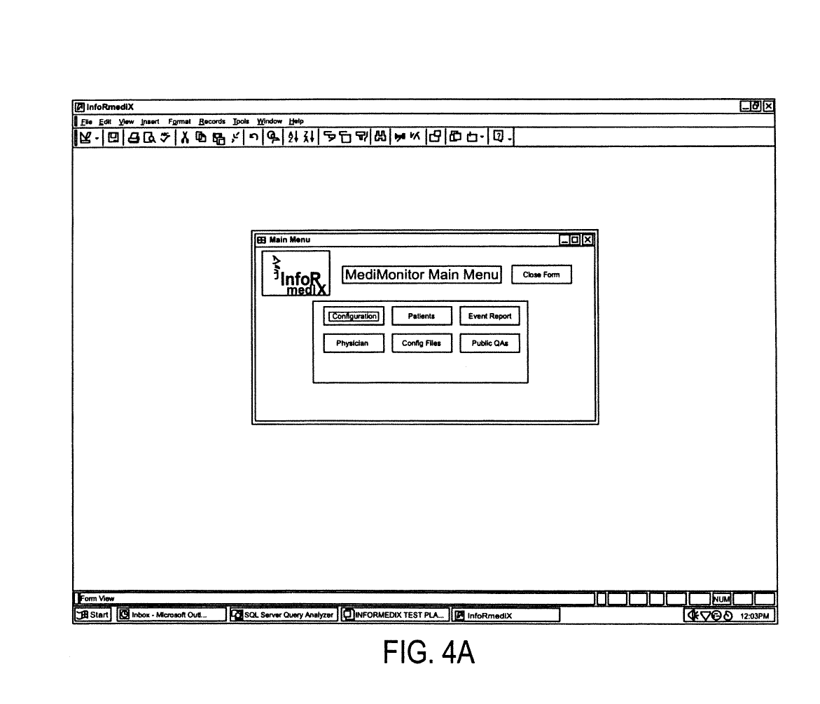

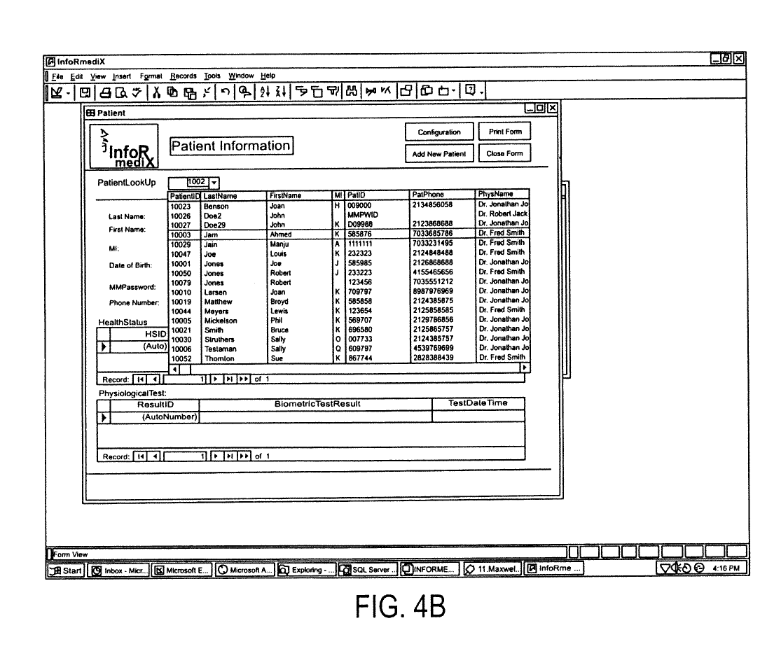

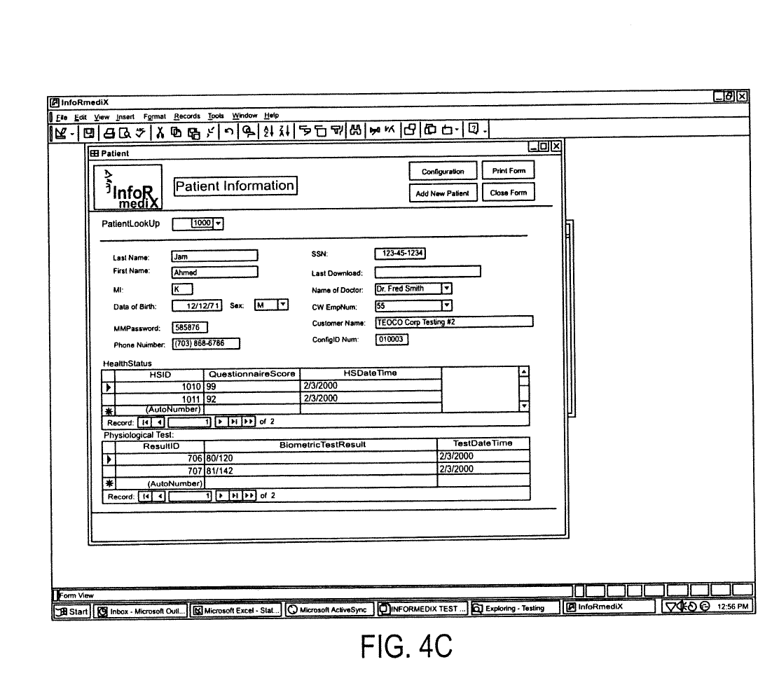

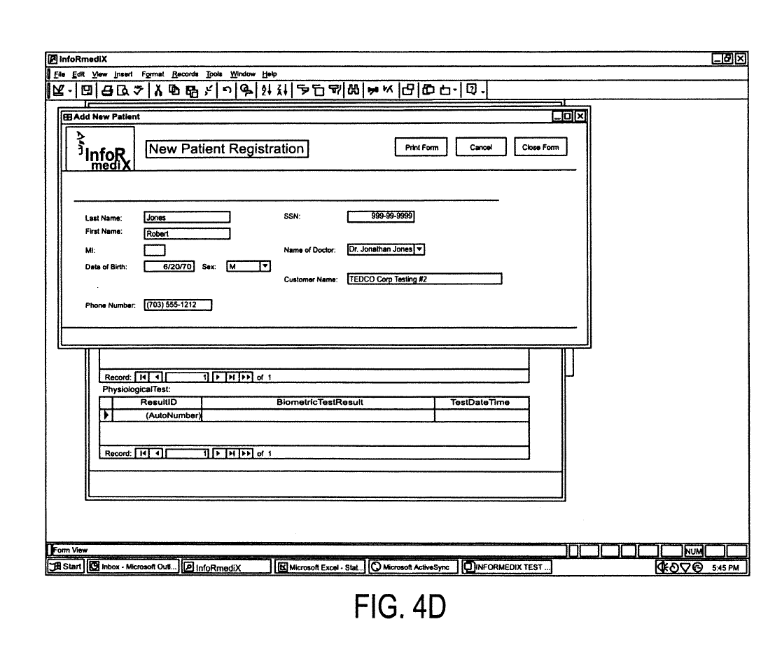

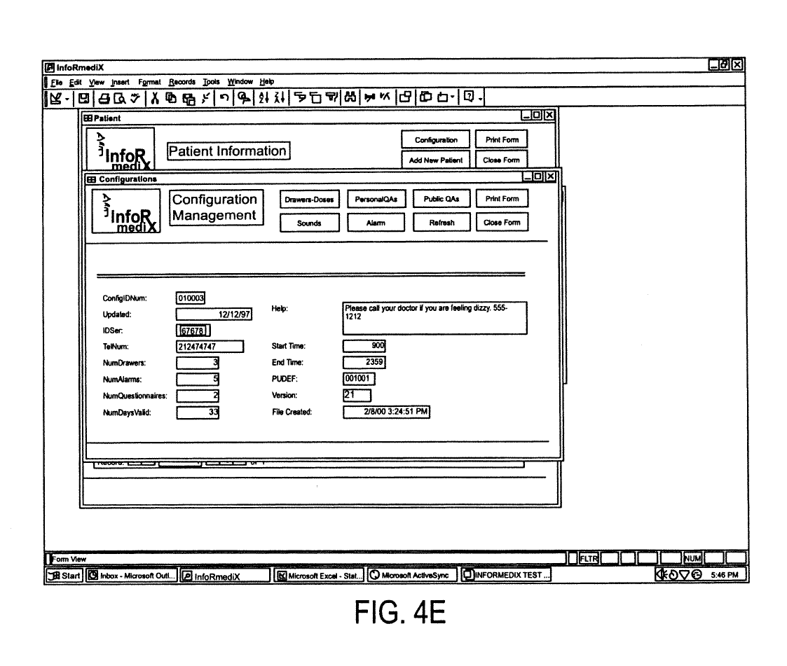

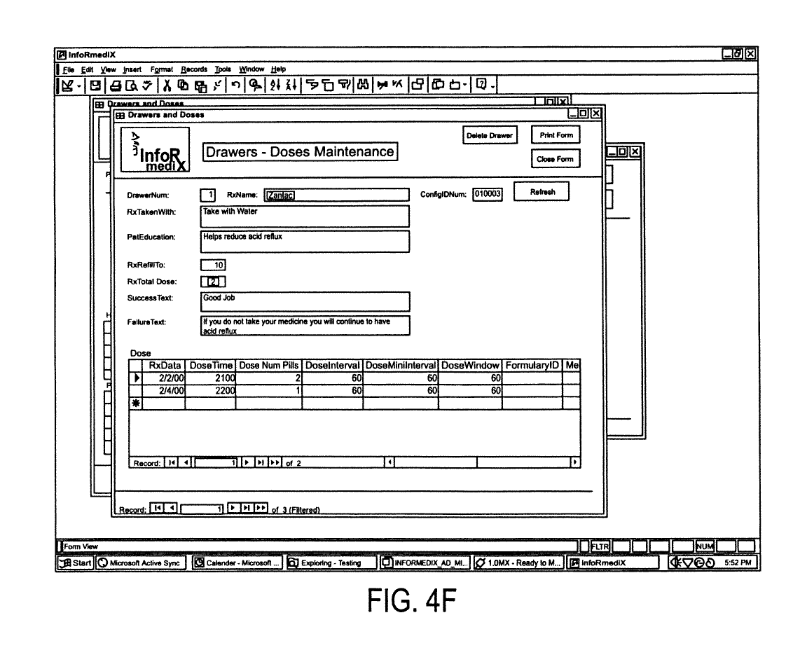

FIG. 4A illustrates a Main Menu screen. From this screen, the user has the has the option of viewing/entering Configurations, Patient(s), Event Reports, Physicians, Public Questions and Answers, and generating new configuration files for download, by pressing the appropriate buttons. All of the information is filtered to show only records related to the login Customer ID. FIGS. 4B-4F below describe the events associated with each of these buttons.

FIG. 4B illustrates the Patients screen. The patients screen shows the patients associated with the login Customer ID. The Patient Lookup drop-down box is populated from that query. The patients are sorted by Last Name, First Name. The first record that appears on the screen is the first record in the PatientLookUp drop-down box. In the example illustrated in FIG. 4B, a particular patient named Ahmed Jaim has been selected from the PatientLookUp drop-down box. The data fields in main form may include: ConfigurationID/ConfigID, Num, Last Name, First Name, MI, Date of Birth, Sex, MMPassword, Phone Number, SSN, Last Download, Name of Doctor, CW EmpNum, and Customer Name. The data fields in the health status subform may include: HSID, Questionnaire Score, and HSDateTime. The data fields in the psychological test subform may include: ResultID, BiometricTestResult, and TestDateTime.

FIG. 4C illustrates how the Patient Information form becomes populated with the patient information for Ahmed Jaim. PatientID is the identifier for a record in this table. The PatientID is the same as the ConfigID (not visible) which is used to link to other information (configuration, events, etc.). The ConfidIDNum is a 6-character representation of the PatientID, usually with a leading zero(s). The subforms in the bottom half of the screen show the Health Status and Physiological Tests for the patient.

FIG. 4D illustrates how new patients are added. From the patient screen, if the user chooses the “Add New Patient” button, a new screen appears. The Customer Name is automatically populated based on the Login and the default First Name is “Medimonitor.” First Name, Sex, and Name of Doctor are required fields. Clicking close will save the record and go back to the Patient Screen. Adding a new patient will automatically update the PatientLookUp drop-down box when the “Close Form” button is clicked. The user can also print the form from the “Print Form” button. The data fields that are provided for adding new patients may include: Last Name; First Name; MI; Date of Birth; Sex; Phone Number; SSN and Name of Doctor.

FIG. 4E illustrates configuration management. This screen can also be accessed directly from the Main Menu (Configuration button). From the Configuration Management screen, the Drawer/Doses information, Questionnaires, Alarms and Sounds can be entered and modified for a patient/configuration ID. The data fields provided for configuration management may include: ConfigNum; Updated; IDSer; TelNum; NumDrawers; NumAlarms; NumQuestionnaires; NumDaysValid; Help; and StartTime.

FIG. 4F illustrates how the medication dose is specified, and other medication educational content displayed. Clicking the drawer-doses button leads to the screen illustrated in FIG. 4F. Each configuration ID can have up to 5 drawers. Each drawer can have up to 10 doses. The data fields provided for the drawer-doses screen may include: ConfigNum; RxRefilTo; DrawerNum; RxTotalDoses; RxTaxenWith; SuccessText; PatEducation; and FailureText. The data fields provides for the fields in Doses subform may include: RX Date; DoseWindow; DoseTime; FormularylID; DoseNumPills; MedicationDescription; DoseMinlNterval; and MedForm. The following validation rules may hold for the medication doses: For each Dose, Minlnterval must be less than or equal to Interval. For each DoseTime+Interval, there must not be any overlapping time with other doses. For example, if there is already a DoseTime (1) of 1000 (10:00 AM) and an Interval of 120 (2 hours) for this dose, there cannot be an entry of another DoseTime (2) with DoseTime between 1000 and 1200.

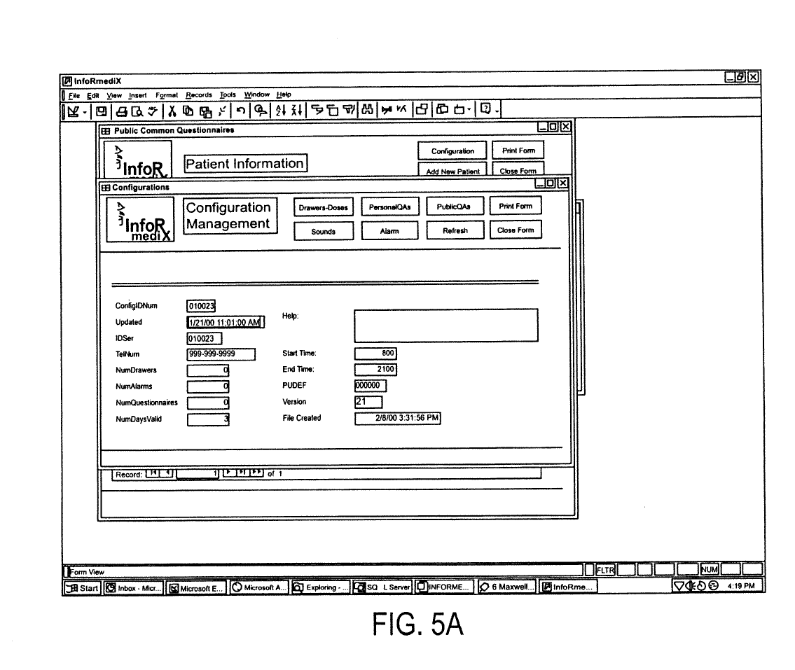

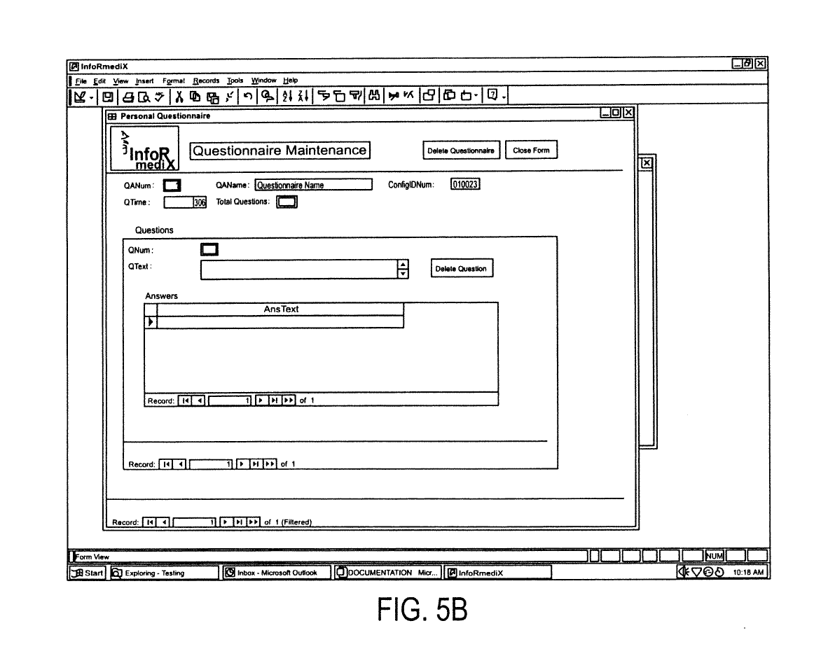

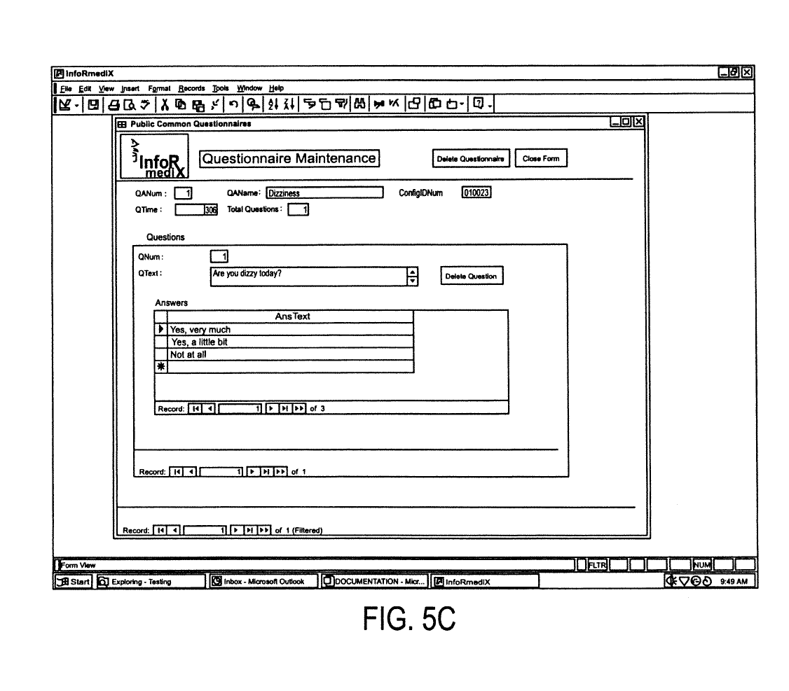

FIG. 5A illustrates how the Questionnaires are accessed. In the illustrated embodiment, access to the Questionnaires is via the Configuration screen. When one type of questionnaire is entered for a configuration, the button for the other type of questionnaire will be disabled. If no questionnaires are entered, both options are open to the user. In this example, ConfigIDNum 010023 does not have any questionnaires, so both options are available.

FIG. 5B illustrates the entering of a Personal Questionnaire for a particular configuration. In the illustrated embodiment, the ConfigIDNum is automatically entered and cannot be changed. Also, in the illustrated embodiment here is a limit of 20 questionnaires per configuration. In the personal questionnaires, there are also limits of 100 questions per questionnaire, and up to 12 answers per question. The record selectors at the bottom show the Questionnaire number (first questionnaire, second questionnaire). The record selectors in the middle show the Question number (question #1 of Questionnaire #1) and the first record selectors show the answer number (Answer #1 from Question #1 of Questionnaire #1). The data fields provided for the drawer-doses screen may include: QA Num (for entry of question/answer number), Total Questions, QAName, Qnum, ConfigIDNum, Qtest, Qtime, and AnsText.

FIG. 5C illustrates a Personal Questionnaire in which one question has been entered which has 3 possible answers. When the user is done entering the questionnaire, the Close Form button will take them back to the Configuration screen.

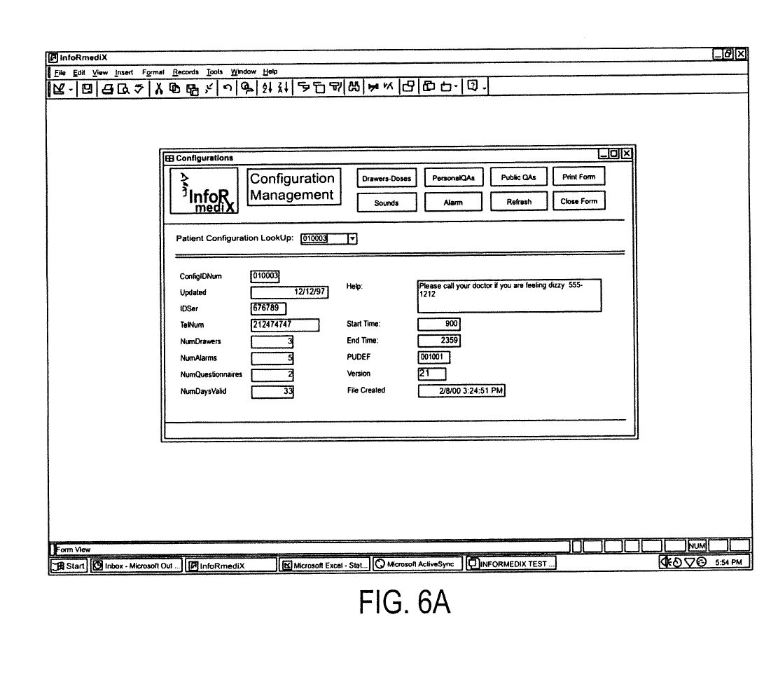

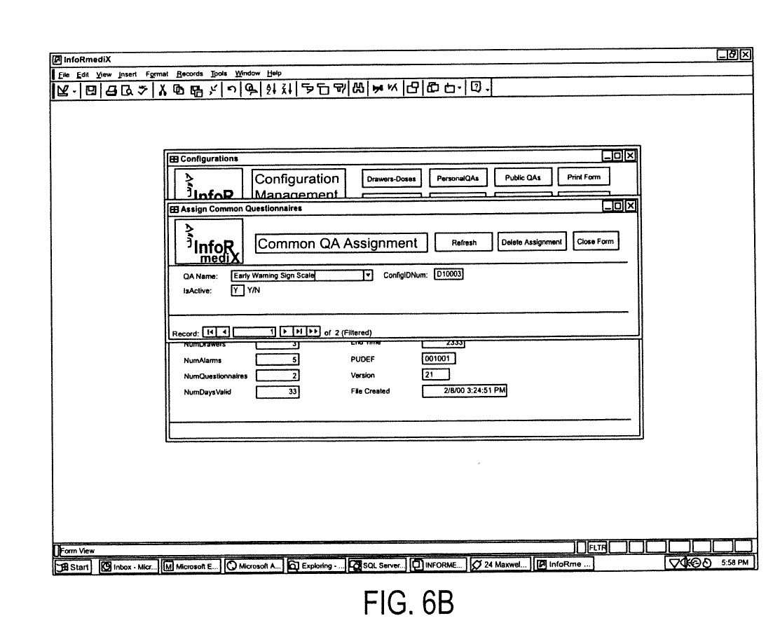

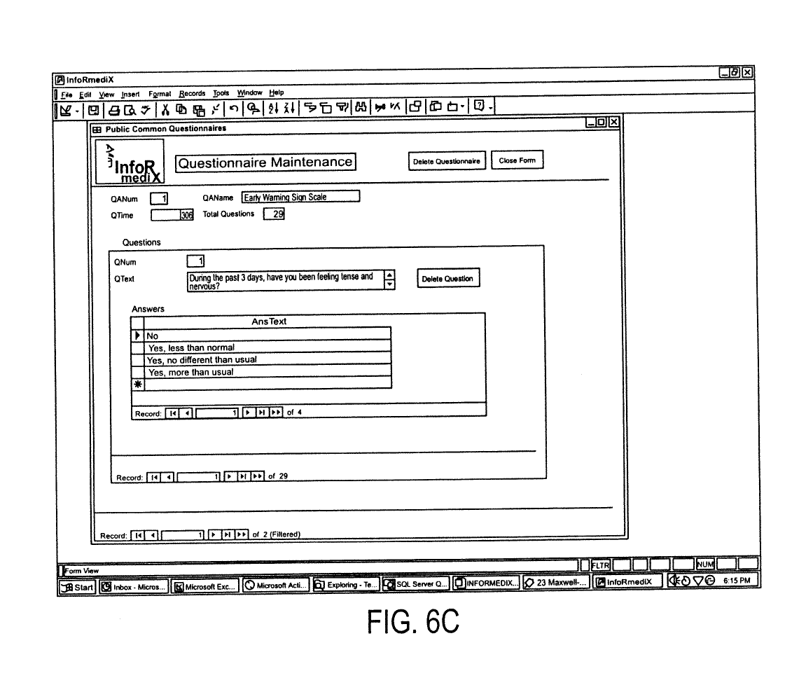

FIGS. 6A-6C illustrate public questionnaires. Public Questionnaires are ones that can be assigned to multiple configurations/patients. FIG. 6A illustrates selection of a public questionnaire. In the example illustrated in FIG. 6A, a configuration is selected that already has a public questionnaire. The user knows this because only the Public QAs button is available (Personal QAs button is disabled). Clicking the Public QAs button will open the screen which allows the user to assign a Public QA to a Configuration.

FIG. 6B illustrates how a public questionnaire is assigned to a configuration. The QA Name drop-down box shows the public questionnaires from which to choose. The ConfigIDNum is automatically populated. The record selectors show the two different questionnaires.

FIG. 6C illustrates the entering and editing of public questionnaires. The Public QA button from the Main Menu takes the user to the screen where Public Questionnaires can be entered and edited. These questionnaires can be assigned to an unlimited number of configurations. The Questionnaires are entered in a similar manner as the Personal Questionnaires discussed above.

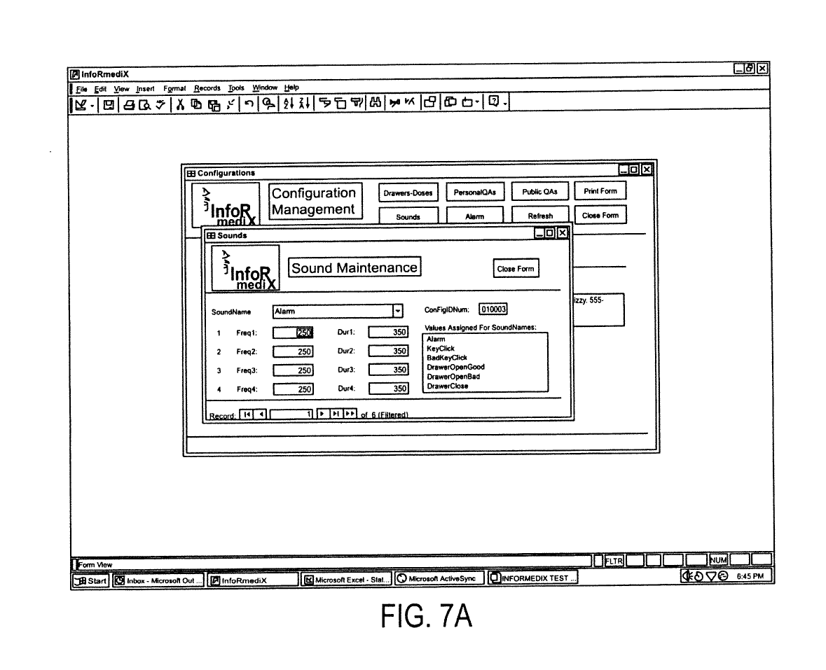

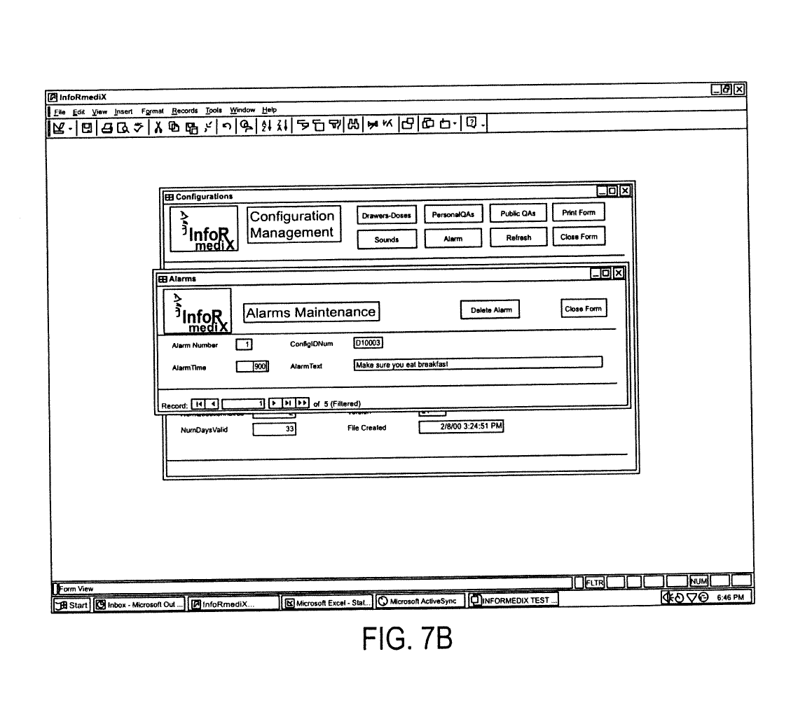

FIGS. 7A-7B illustrate sounds and alarms. FIG. 7A illustrates the sounds screen. Clicking on the Sounds button from the Configuration Management screen leads to the Sound Maintenance Screen. Here the sounds can be edited for the selected ConfigNum. In the illustrated embodiment, the range of frequencies are from 0 to 20,000 and is measured in hertz. A frequency of 0 is no sound or a delay with no sound. The time element is measured in milliseconds, and a range of 1 to 5000 (5 seconds) is the allowable range.

FIG. 7B illustrates the alarm screen. Clicking on the Alarms button from the Configuration Management screen leads to the Alarm Maintenance Screen. Alarms can be set and/or edited from this screen. Each alarm configuration is based on the selected ConfigNum.

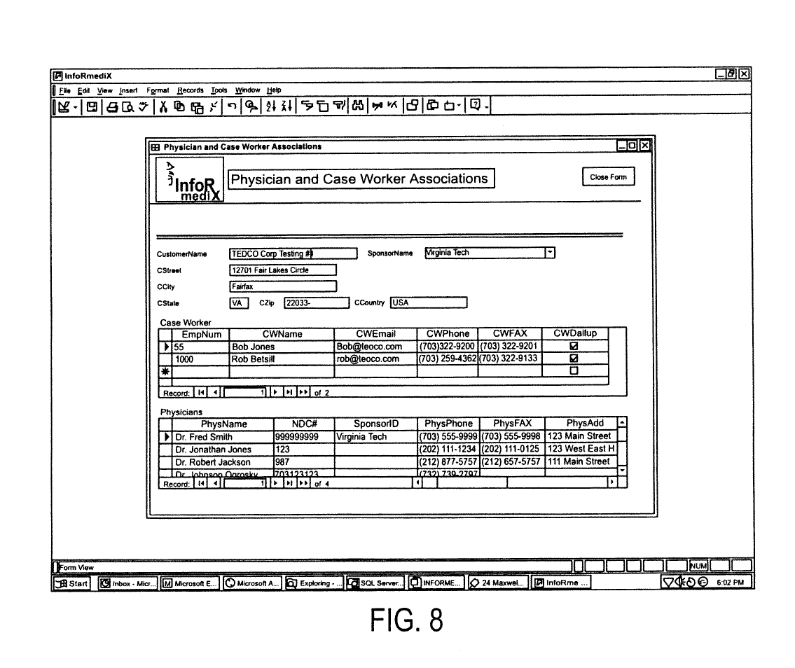

FIG. 8 illustrates the creation of physician and case worker files. Clicking on the Physicians button from the Main Menu screen leads to the Physicians and Case Worker Associations Screen. This is the screen where the Physician and Case Worker Associations are created. The Customer Name, Sponsor Name, and Address Information are also stored here. The case worker subform fields include: EmpNum, CWPhone, CWName, CWFax, Cwemail, and CWdialup. The physicians subform fields include: PhysName, PhysAdd, NDC#, PhysCity, Sponsor ID, PhysState, PhysPhone, PhysZip, PhysFax.

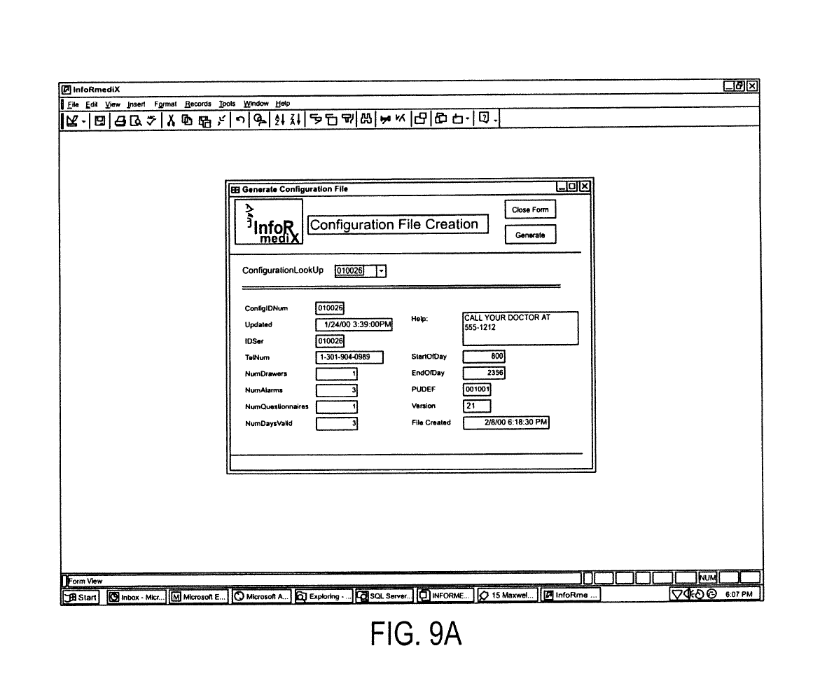

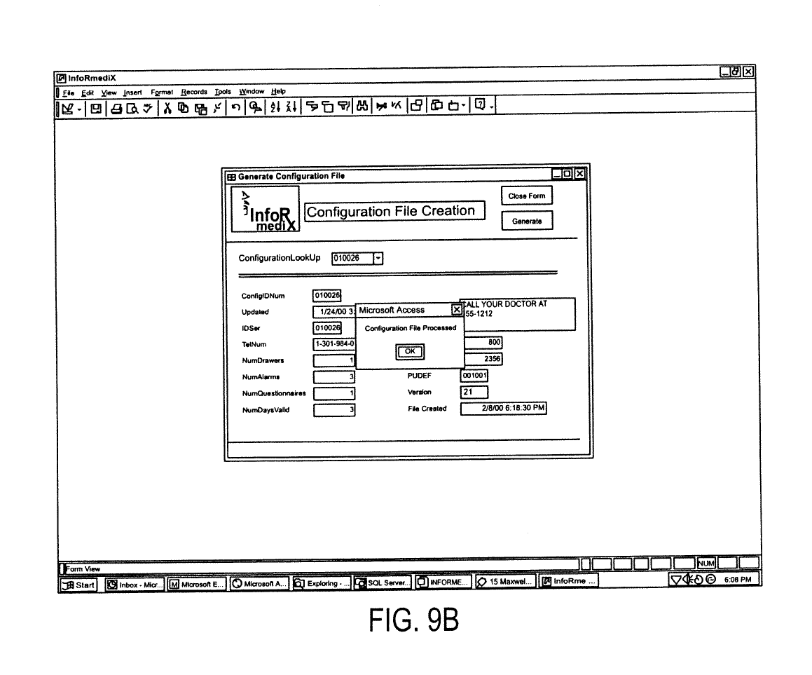

FIGS. 9A-9B illustrates the generation of configuration files. The ConfigFiles button in the Main Menu (illustrated in FIG. 4A) is where the ConfigFiles are generated. FIG. 9A illustrates the screen where the Configuration Files are generated. A configuration is chosen from the ConfigurationLookUp drop-down box, which will populate the screen. The user then clicks the Generate button, in order to generate the configuration file. In one embodiment, a “downloads” screen may lead to the ConfigFiles screen. Statistics data generation may also be made to be available from this screen.

As shown in FIG. 9B, a message will appear which shows that the table has been appended, and the Configuration File has been generated. The ConfigID and the time of the configuration generation will be stored in the ConfigFiles table automatically when this procedure is run.

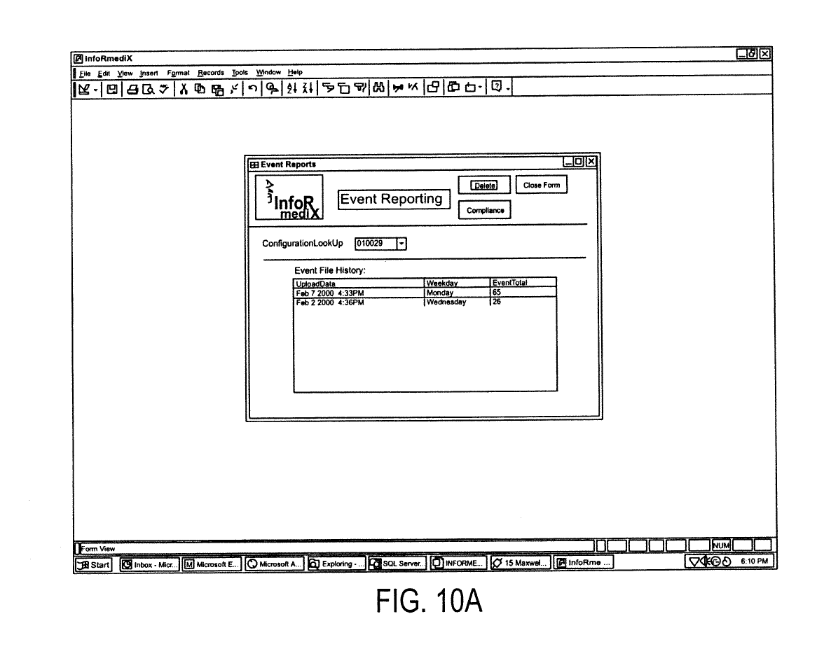

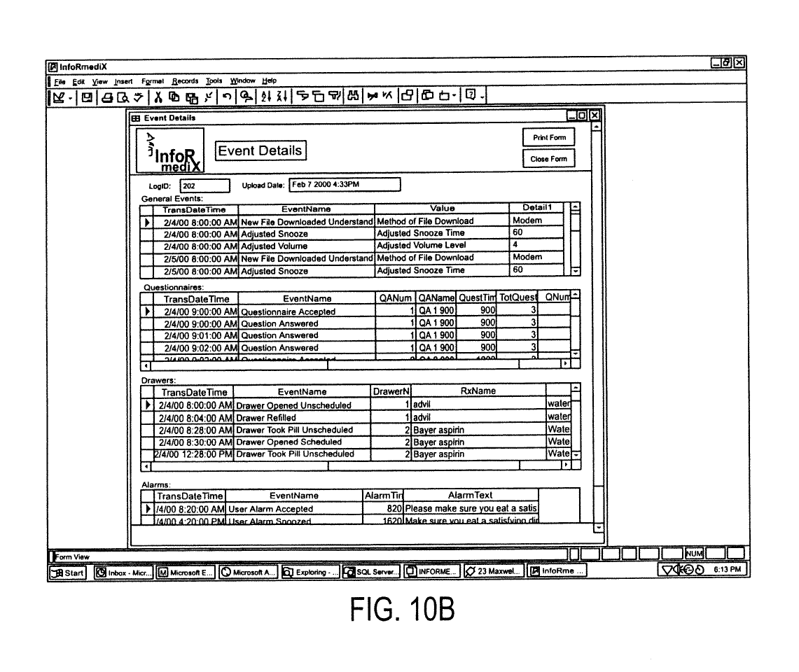

FIGS. 10A and 10B illustrate event reporting and event details. In FIG. 10A, the event reporting screen is shown. The Event Reporting information is available from the “Events Report” button on the Main Menu. The Event File History is maintained here. If the user selects an event from the subform titled “Event File History” and clicks on details, details of the event are available. In the illustrated example, ConfigID 10029 and the first Event File History have been selected.

In the form shown in FIG. 10B, the Event Details are shown for the selected event. All of the General Events, Questionnaires, Drawers and Alarm information is available here for viewing. The data fields for Event Details may include: LogID, and Upload Date. The General Events Subform fields may include: TransDateTime; EventName; Value; and Detail1. The Questionnaire subform fields may include: TransDateTime; EventName; QANum; QAName; QuesTime; TotQues; Qnum; Qtext; AnsNum; and AnsText. The Drawers Subform fields may include: TransDateTime; EventName; DrawerNum; RxName; RxTakenWith; RxPatEd; RxRefillTo; RxTotalDoses; SuccessText; and FailureText. The Alarms subform fields include: TransDateTime; EventName; AlarmTime; AlarmText.

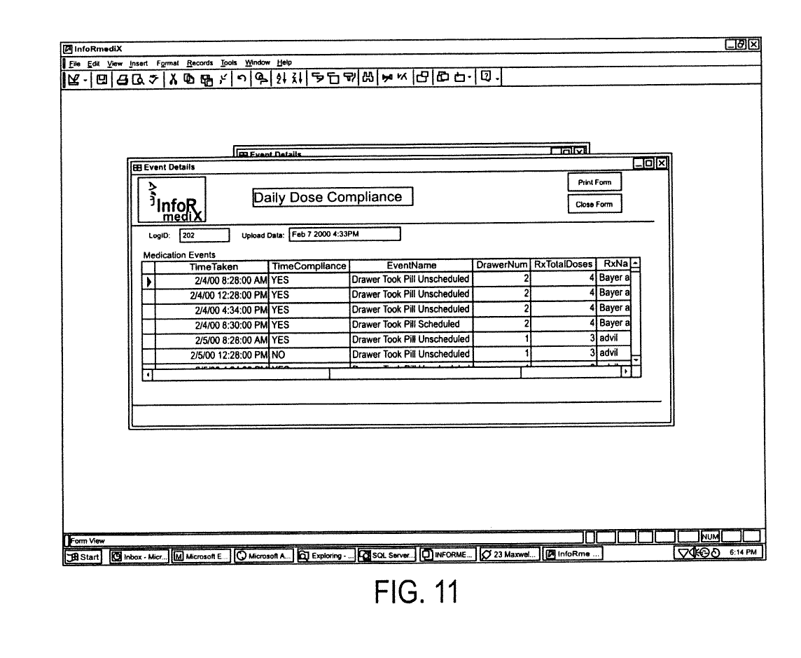

FIG. 11 illustrates the compliance screen, which tabulates whether or not the prescribe medication dose intake has been carried out. From the Event Details button, selecting an Event and clicking the “Compliance” button shows the Daily Dose compliance for that event. The data fields for the “Daily Dose compliance” screen may include: LogID and Upload Date. The medication events subform fields may include: TimeTaken, TimeTaken; TimeCompliance; EventName; DrawerNum; RxTotalDoses; RxName; DoseNum; DoseTime; DoseMin; and DoseWindow.

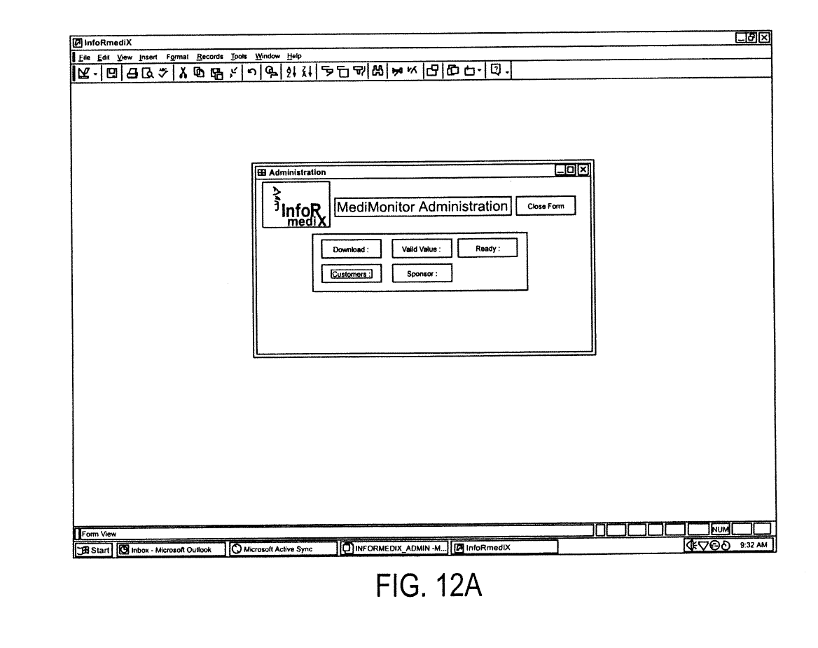

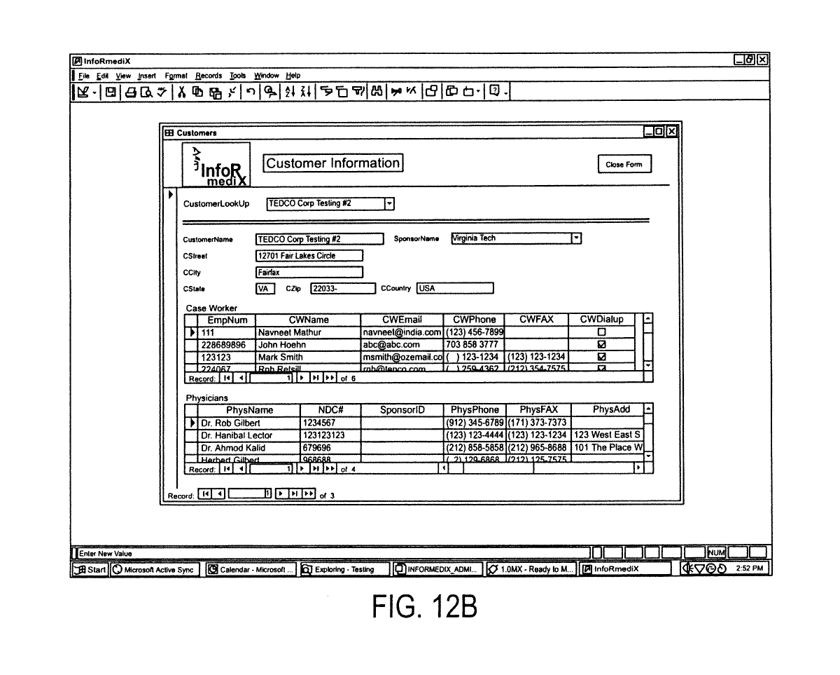

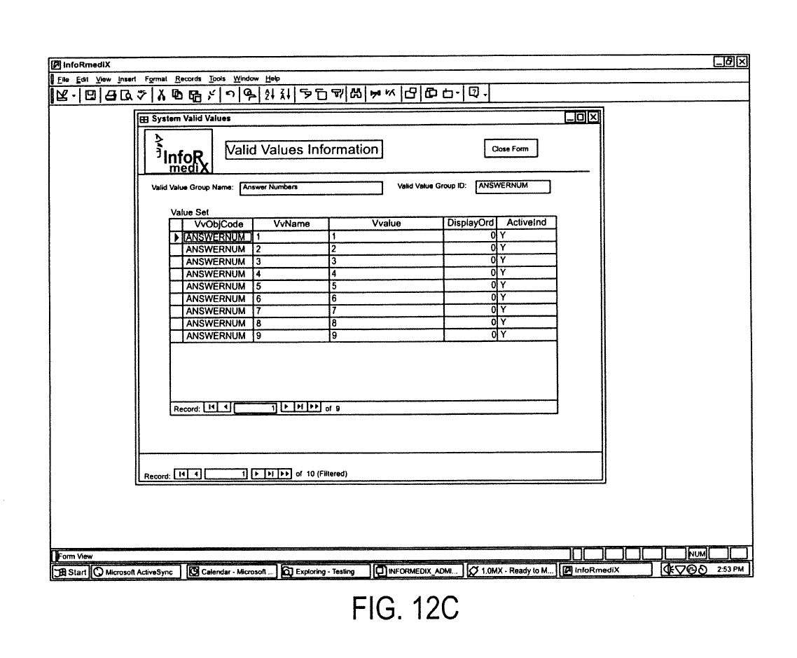

FIGS. 12A-12C illustrate the administration and the customer screens. FIG. 12A illustrates the Admin Screen. The “Medimonitor Administration” Screen appears when entering the Administration section of the database. All information through this screen allows access to information for all of the customers.

FIG. 12B illustrates the Customers Screen. Clicking on the “Customers” button from the Main Menu screen leads to the Customer Administration/Physicians and Case Worker Associations Screen. This is the screen where the Physician and Case Worker Associations are created and/or edited. The Customer Name, Sponsor Name, and Address Information are also stored here. In the illustrated embodiment, the user can use the CustomerLookUp List Box to select the Customer to modify.

FIG. 12C illustrates the “Valid Values” screen, which provide information on the valid values of certain responses to queries. The “Valid Values” button from the Admin Screen leads to the Valid Values Information Screen. Valid values are used to populate drop down selection lists (drop down boxes) and validate user entry. The Valid Values may be read-only, but may be read and write as needed, so that they may be modified.

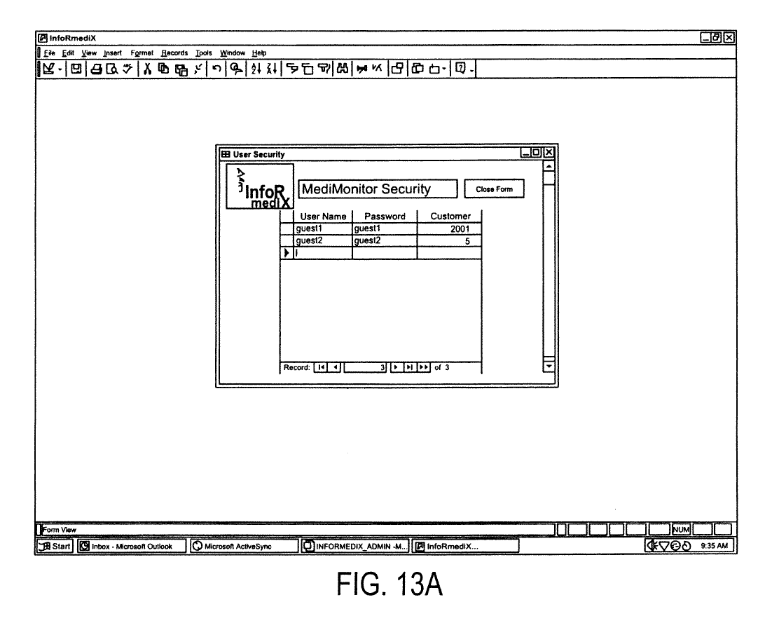

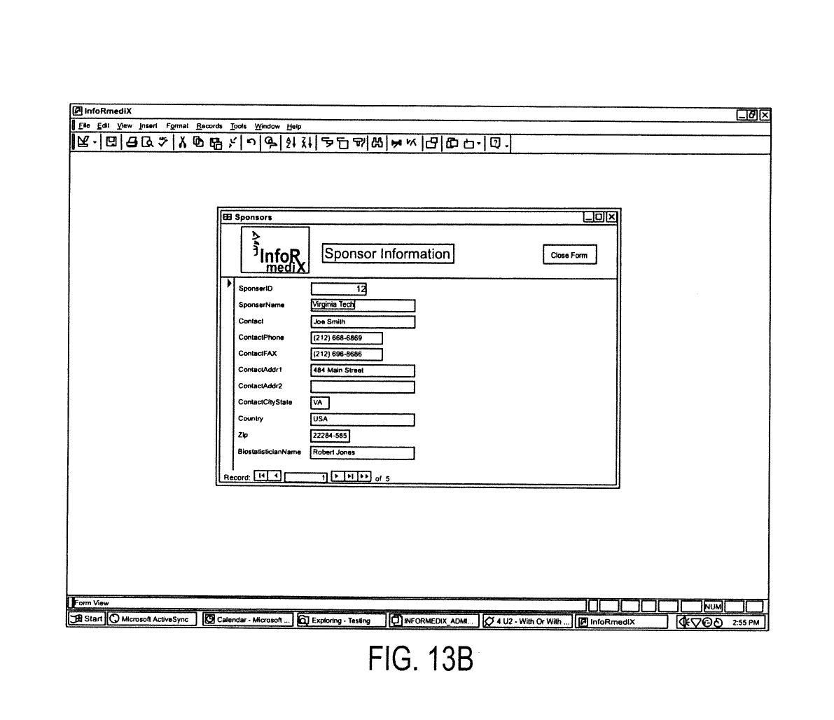

FIGS. 13A-13B illustrate the “Security” screen and the “Sponsors” screen. The “Security” screen, illustrated in FIG. 13A, can be accessed from the Admin Screen. The “Security” button from the Admin Screen leads to the Security Screen. User Names and Passwords can be created and/or edited for each customer in this screen. Detailed information pertaining to sponsors is entered in the “Sponsor Information” screen, shown in FIG. 13B.

In sum, using the method and system described above, complex medication treatment regimens may be monitored for patients who are managed by one or more medical treatment or clinical research protocols or plans. These medical treatment plans may involve pharmaceutical drugs, physiologic data, treatment instructions, medical educational content, medication compliance assessment, and health status or quality of life questionnaire. The method and system described above can optimize patient outcomes, and minimize costs, drug side effects, and adverse drug events.

While the medication treatment monitoring and reporting system have been described and shown with reference to specific embodiments, it should be understood by those skilled in the art that various changes in form and detail may be made therein. Many other embodiments are possible. Other embodiments are within the claims listed at the end of this specification.

### APPENDIX I EVENTS LOG MEDI MONITOR EVENT

### LOG DESCRIPTION V1.1

### Document History

### LOG FILE

### Purpose

### Event IDs

### File Format

### FILE EVENTS

POWER ON EVENT
FILE DOWNLOADED EVENT)
FILE PASSED
FILE FAILED
NEW MEDICAL FILE DOWNLOAED USER ACCEPTANCE

### ANY CHANGES TO MEDICATION BY USER

### UNIT ADJUSTABLE EVENTS

### ADJUST TIME EVENT

### ADJUST VOLUME EVENT

### ADJUST SNOOZE EVENT

### ADJUST CONTRAST EVENT

### QUESTIONNAIRE EVENTS

QUESTIONNAIRE ACCEPTED
QUESTIONNAIRE DECLINED/SNOOZE
QUESTION ANSWERED

### USER ALARM EVENTS

USER ALARM ACCEPTED
USER ALARM MISSED
USER ALARM SNOOZED

### DRAWER EVENTS

DRAWER OPENED UNSCHEDULED
DRAWER TOOK PILL UNSCHEDULED
DRAWER OPENED SCHEDULED
DRAWER TOOK PILL SCHEDULED
UNABLE TO TAKE PILL
DRAWER MISSED MEDICATION (ID=130)
DRAWER SNOOZED MEDICATION (ID=150)
DRAWER REFILLED (ID=155)

### EVENT CHART

### Log File

### Purpose

This document will give detailed information regarding all the possible events that may be included within an event log file that the Medi-Monitor stores. This log file can then be retrieved by a host system in order to find out exactly what a given patient has performed over the past day.

### Event IDs

Each possible event is identified by a unique identification number. This unique number corresponds with an event that is described in this document.

### File Format

When an event is to be recorded, a number of items are also stored along with it. Each event records the date and time of the event as well as any associated necessary data. The file can be broken down and seen through a simple text editor. A typical event is as follows:
19980101080000100000000
This is broken down as follows:
Digits 1-4: Year
Digits 5-6: Month
Digits 7-8: Day
Digits 9-10: Hour
Digits 11-12: Minute
Digits 13-14: Second
Digits 15-17: Event ID
Digits 18-20: Event ID Attribute 1
Digits 21-23: Event ID Attribute 2
Digit 24: CR (Carriage Return—0x0D)
Digit 25: LF (Line Feed—0x0A)

### File Events

The events in this section deal with the downloading, updating, and changing of the medical file that is sent to the unit.

Power on Event (ID=1)

This event occurs when the unit is first initialized. This occurs only once with each unit.

File Download Event (ID=5)

This event indicates that a connection has been made with the unit and a medical file has been downloaded into the unit.

There is 1 attribute associated with this event. The two possibilities are as follows:
ID: 000—Downloaded via infared port
ID: 001—Downloaded via modem

File Passes (ID=6)

This event indicates that the recently downloaded medical file has passed all necessary tests and will be used within this unit.

File Failed (ID=7)

This event indicates that the recently downloaded medical file has failed one of the tests and will not be utilized.

New Medical File Download User Acceptance (ID=8)

After a new medical file is downloaded into the unit, the user must acknowledge that the medical file has been updated by responding to a notice of this event, being questioned regarding their understanding, and indicating, “I understand” or “I don't understand.” This event corresponds to the acceptance or lack of acceptance and understanding by the user.

Any Changes to Medication by User (ID=9)

After a new medical file is downloaded into the unit, the user must acknowledge that the medical file has been updated. This event means that the user does not understand that the medical file has been changed.

### Unit Adjustable Events

The events in this section pertain to the times when a user updates one of the unit settings.

Adjust Time Event (ID=10)

This event corresponds to the action by the user to change the current time.

Adjust Volume Event (ID=12)

This event corresponds to the action by the user that they have changed the volume. The first attribute corresponds to the new volume level selected.

Adjust Snooze Event (ID=14)

This event corresponds to the action by the user that they have changed the snooze time. The first attribute corresponds to the new time selected.

Adjust Contrast Event (ID=16)

This event corresponds to the action by the user that they have changed the contrast of the display.

### Questionnaire Events

The events in this section pertain to the times when questions are to be given to a user.

Questionnaire Accepted (ID=20)

This event occurs if the user selects the OK button when it is time to take a questionnaire. This event has two attributes, attribute 1 corresponds to the questionnaire number. Attribute 2 will be utilized to provide the Pin Code entry when accepting to answer the questioner or acknowledge an unscheduled event.

Questionnaire Declined/Snooze (ID=21)

This event occurs when the user selects the snooze button instead of taking the set of questions at this time. This event has a single attribute, this attribute corresponds to the questionnaire number.

Question Answered (ID=25)

Each time a question is answered, this event is recorded. There are 3 associated attributes with this event. The first is the Questionnaire number, the second is the Question number that was answered, and the third is the answer selected by the user.

### User Alarm Events

The events in this section deal with user alarms which are instructions to the user who must perform these actions on their own. The events record the users actions regarding these events.

User Alarm Accepted (ID=30)

This event occurs when a user alarm is accepted by the user. This event has 1 associated attribute. This attribute is the alarm number.

User Alarm Missed (ID=32)

This event occurs if over the course of the day, the user never accepts the alarm. This event has 1 associated attribute. This attribute is the alarm number.

User Alarm Snoozed (ID=34)

This event occurs when the user does not accept the user alarm at this time but instead selects the snooze button. This event has 1 associated attribute, this attribute is the alarm number.

### Drawer Events

The drawer events in this section record all actions regarding opening and closing drawers and the taking of pills at the pre-perscribed times.

Drawer Opened Unscheduled (ID=100)

This event occurs when the user opens one of the drawers when they are not scheduled to do so. The one associated attribute is the drawer number.

Drawer Took Pill Unscheduled (ID=105)

This event occurs when a user takes a pill at an unscheduled time. The one corresponding attribute is the drawer number.

Drawer Opened Scheduled (ID=110)

This event occurs when a user opened a drawer within the scheduled time period. The one corresponding attribute is the drawer number.

Drawer Took Pill Scheduled (ID=115)

This event occurs when a user takes a pill during the scheduled time period. The one corresponding attribute is the drawer number.

Unable to Take Pill (ID=125)

This event corresponds to a user explaining why they cannot take a pill at this time. There is one attribute and may be one of two options. If the person needs a refill, the attribute is 000. If they cannot take it because of a side effect, the attribute is 001.

Drawer Missed Medication (ID=130)

This event means that the user has missed a scheduled medication. The one attribute is the drawer number.

Drawer Snoozed Medication (ID=150)

This event occurs when a user snoozes a scheduled medication. The one attribute is the drawer number.

Drawer Refilled (ID=155)

This event occurs when the user refills a drawer with pills. The one attribute is the drawer number.

### Event Chart

| | Event ID | Event | Event | Event |
|---|---|---|---|---|
| | Number | Attribute 1 | Attribute 2 | Attribute 3 |
| Event Description | (3 digits) | (3 digits) | (3 digits) | (3 digits) |
| POWER ON | 001 | 000 | 000 | 000 |
| FILE DOWNLOADED | 005 | Method of | 000 | 000 |
| | | download | | |
| | | (000 - IR Port) | | |
| | | (001 - Modem) | | |
| FILE PASSED | 006 | 000 | 000 | 000 |
| FILE FAILED | 007 | 000 | 000 | 000 |
| NEW MED FILE - USER | 008 | IDNum first 3 | IDNum last | 000 |
| ACCEPTANCE | | digits | 3 digits | |
| CHANGES TO MED FILE | 009 | 000 | 000 | 000 |
| BY USER | | | | |
| ADJUSTED TIME | 010 | 000 | 000 | 000 |
| ADJUSTED VOLUME | 012 | Volume Level | 000 | 000 |
| | | (000-007) | | |
| ADJUSTED SNOOZE | 014 | Snooze Time | 000 | 000 |
| | | (001-120) | | |
| ADJUST CONTRAST | 016 | 000 | 000 | 000 |
| QUESTIONNAIRE | 020 | Questionnaire | Pin Code | 000 |
| ACCEPTED | | Number | Entry | |
| | | (001-MAX) | | |
| QUESTIONNAIRE | 021 | Questionnaire | 000 | 000 |
| SNOOZED | | Number | | |
| | | (001-MAX) | | |
| QUESTION ANSWERED | 025 | Questionnaire | Question | Answer |
| | | Number | Number | Number |
| | | (001-MAX) | (000-MAX) | (000-MAX) |
| USER ALARM ACCEPTED | 030 | Alarm Number | 000 | 000 |
| | | (001-MAX) | | |
| USER ALARM MISSED | 032 | Alarm Number | 000 | 000 |
| | | (001-MAX) | | |
| USER ALARM SNOOZED | 034 | Alarm Number | 000 | 000 |
| | | (001-MAX) | | |
| DRAWER OPENED | 100 | Drawer Number | 000 | 000 |
| UNSCHEDULED | | (001-005) | | |
| DRAWER TOOK PILL | 105 | Drawer Number | 000 | 000 |
| UNSCHEDULED | | (001-005) | | |
| DRAWER OPENED | 110 | Drawer Number | 000 | 000 |
| SCHEDULED | | (001-005) | | |
| DRAWER TOOK PILL | 115 | Drawer Number | 000 | 000 |
| SCHEDULED | | (001-005) | | |
| UNABLE TO TAKE PILL | 125 | Why cannot take | 000 | 000 |
| | | (000 - need refill) | | |
| | | (001 - side effect) | | |
| MISSED MEDICATION | 130 | Drawer Numer | 000 | 000 |
| | | (001-005) | | |
| SNOOZED MEDICATION | 150 | Drawer Number | 000 | 000 |
| | | (001-005) | | |
| DRAWER REFILLED | 155 | Drawer Number | 000 | 000 |
| | | (001-005) | | |

BST99 1418477-1.047984.0043

### APPENDIX II USE CASE SCENARIOS

PUC 01. Creating a New Site.

1.1 Use Case Diagram
None.

1.2 Purpose (Description)
The purpose of this process level use case is to provide the steps and actors involved during site creation.

1.3 Actors
1. System Administrator.
2. Site Administrator.

1.4 Preconditions (Assumptions)
1. The System Administrator has a valid user account.

1.5 Main Flow (Steps)
1. The System Administrator logs into the system. [UC 01].
2. The System Administrator creates the new site name. [UC xx].
3. The System Administrator creates a Site Administrator user account consisting of one login ID and password. [UC 21].
4. The System Administrator notifies the Site Administrator that the new Site Administrator user account has been successfully created.
5. The System Administrator may optionally log off of the system at this time. [UC 11].
6. The Site Administrator logs into the system. [UC 01].
7. The Site Administrator enters the generic information about the new site (name, address, phone, etc.). [UC 28].
8. The Site Administrator may optionally create new user accounts. [UC 21].
9. The Site Administrator may optionally create new study groups. [UC 05].
10. The Site Administrator may optionally add new users. [UC 09].
11. The Site Administrator may optionally assign users to study groups. [UC 28].
12. The Site Administrator logs off of the system. [UC 11].

1.6 Sub Flow(s) (Variations)
None.

1.7 Exceptions
None.

1.8 Issues
1. CRB 4/25/00: I think step 2 should be removed. I don't believe the System Admin should be the one to create the site name. I think he should set up the login id for the system admin. Then when the site admin logs in for the first time, she is required to name her site and enter all required information about it. This information is stored centrally. Each site has a unique site id associated with it that is system generated.
2. For step number 3, won't the Site Administrator also need to be given a site number? The Site Administrator needs to be identified with a site somehow.

1.9 Non-Functional System Requirements
None.

PUC 02. Creating a New Group.

1.10 Use Case Diagram
None.

1.11 Purpose (Description)
The purpose of this process level use case is to provide the steps and actors involved in creating new groups.

1.12 Actors
3. Site Administrator.
4. Caregiver.

1.13 Preconditions (Assumptions)
1. The site has been created. [PUC 01].

1.14 Main Flow (Steps)
13. The Site Administrator logs into the system. [UC 01].
14. The Site Administrator adds a new group. [UC 05].
15. The Site Administrator adds new users. [UC 21].
16. The Site Administrator optionally assigns users to the group. [UC 28].
17. The Site Administrator optionally logs off of the system. [UC 11].
18. The Caregiver logs into the system. [UC 01].
19. The Caregiver optionally assigns a sponsor to the group. The Site Administrator could perform this function as well. [UC 24].
20. The Caregiver creates a patient. The Site Administrator could perform this function as well. [UC 08].
21. The Caregiver creates a patient configuration file starting with a group level configuration template. [UC 06].
22. The Caregiver updates the configuration file to add dosage information, modify sounds, or modify alarms. [UC 06].
23. The Caregiver optionally updates questionnaires. [UC 07].
24. The Caregiver may repeats steps above to create other patients and add other patients to the group.
25. The Caregiver logs off the system. [UC 11].

1.15 Sub Flow(s) (Variations)
None.

1.16 Exceptions
None.

1.17 Issues
1. How does step number 9 fit in with PUC 03 and Abbreviated config files?
   CRB 4/2800: Step 9 above should relate to UC 06 not UC 02 (changed above). The caregiver selects an existing template and edits it for the individual patient.
2. For step 10, is this updating questionnaires in the patient's config files or actually updating the questionnaire?
   CRB 4/2800: I am envisioning that only the questionnaire on the patients configuration is updated. The saved questionnaire template would not be changed.

1.18 Non-Functional System Requirements
None.

PUC 03. Deploying the Med-eMonitor™

1.19 Use Case Diagram
None.

1.20 Purpose (Description)
The purpose of this process level use case is to illustrate the steps and actors involved with starting a patient on the Med-eMonitor™ system.

1.21 Actors
5. Caregiver.
6. Patient.

1.22 Preconditions (Assumptions)
1. Patient must exist. [UC 08].
2. Patient configuration must exist. [UC 02].
3. A Med-eMonitor™ device must be assigned to give to a patient.
4. A Med-eMonitor™ device must be preloaded with the appropriate medicines.

1.23 Main Flow (Steps)
26. The caregiver logs into the system. [UC 01].
27. The caregiver updates the patient's configuration file that is stored in the system. [UC 06].
28. The caregiver chooses to generate a new configuration file for the new patient configuration. [UC 06].
29. The caregiver loads the abbreviated patient configuration file into the Med-eMonitor™ device.
30. The Med-eMonitor dials in when placed into the cradle by the patient.
31. The Med-eMonitor retrieves the caregiver specified patient configuration file.
32. The Med-eMonitor™ device alerts the patient to take medications at the times specified in the configuration file.
33. The patient takes the medications.
34. The Med-eMonitor™ device stores the event data.
35. At a pre-programmed time of day, the Med-eMonitor™ device uploads any new event data to the system.
36. The system downloads any new configuration changes to the Med-eMonitor™ device.
37. The caregiver optionally views event data. [UC 04].
38. The caregiver optionally views compliance data. [UC 10].
39. The caregiver logs off of the system. [UC 11].

1.24 Sub Flow(s) (Variations)
None.

1.25 Exceptions
None.

1.26 Issues
1. Why do we need the precondition: “A Med-eMonitor™ device must be preloaded with the appropriate medicines”?
2. Should generating the configuration file be part of UC 6? Or is it a separate UC? We don't have anything allocated for this yet.
3. Do we need a UC to do uploads/downloads from the Med-eMonitor?

1.27 Non-Functional System Requirements
None.

Actors:
Caregiver (doctor, nurse, pharmacist, physicians assistant, etc.)
Patient
Family Member
Analyst
Caseworker
Site Administrator
System Administrator
System Timer

Documented use cases:
UC 01: Log on to the system.
UC 02: Add a group level configuration template.
UC 03: View/Update patient information.
UC 04: Summarize patient events.
UC 05: Add a new group.
UC 06: View/Update patient configurations.
UC 07: View/Update questionnaires.
UC 08: Add a new patient.
UC 09: Add new user information.
UC 10: Determine daily dosage compliance.
UC 11: Log off of the system.
UC 12: Retrieve event details.
UC 13: Archive patient information.
UC 14: Archive user information.
UC 15: View/Update user information.
UC 16: Archive group information.
UC 17: View/Update a group.
UC 18: Add a valid value. (FUTURE?)
UC 19: View/Update a valid value. (FUTURE?)
UC 20: Delete a valid value. (FUTURE?)
UC 21: Add a new user account to the system.
UC 22: View/Update an existing user account.
UC 23: Deactivate a system user account.
UC 24: Add a new sponsor.
UC 25: View/Update sponsor information.
UC 26: Archive sponsor information.
UC 27: View/Update site information.
UC 28: Assign a user to a group.
UC 29: Add a new questionnaire.
UC 30: Import patient events.

Potential FUTURE use Cases
Generate statistics.
Delete a configuration.
Add a public configuration.
Print configuration data.
Run canned reports.
Run canned queries.
Create an ad hoc query.
Send custom messages (wireless).
Create branching questionnaires.
Archive a questionnaire.
Change a password.
Import patient data.
Export data.
Provide a GUI for audit trail/log events.

UC 01. Log on to the System.

1.28 Use Case Diagram
None.

1.29 Purpose (Description)
This use case provides the capability for an operator to log on to and be authenticated by the Med-eMonitor™ system.

1.30 Actors
7. Caregiver
8. Patient
9. Family member
10. HMO Caseworker
11. Analyst
12. System administrator
13. Site administrator

1.31 Preconditions (Assumptions)
1. The operator has a valid user account, consisting of an id and a password, to access the system.

1.32 Main Flow (Steps)
40. The operator chooses to enter the system.
41. The system displays a login screen.
42. The operator is prompted to enter a user id and a password. [SF 01: First time login].
43. The system authenticates the information provided by the operator. [SF 02: Authentication failure].
44. The system determines that the operator is not an administrator. [SF 03: Operator is authenticated as an administrator].
45. The system displays the groups that the operator is allowed to access.
46. The operator selects a group.
47. The main menu is displayed.

1.33 Sub Flow(s) (Variations)
SF 01: First time login.
1. If this is the first time the operator has logged in, the operator is prompted to change the current password.
2. The operator enters the new password.
3. The system asks the operator to re-enter the password to confirm the password.
4. The operator re-enters the password.
5. The system checks to ensure that the passwords are equal.
6. If the passwords are not equal the system asks the operator to try to enter and reconfirm the new password again.
7. If the passwords are equal the system saves the new password to the database.
SF 02: An authentication failure occurs because the data entered is not correct or the user account has been inactivated.
1. If the system determines that the user id or password is not correct, an error message is displayed.
2. The operator acknowledges the error.
3. The login screen is re-displayed. [EX 01 Operator has exceeded maximum number of login attempts].
SF 03: Operator is authenticated as an administrator.
1. The system determines that the operator is an administrator.
2. The administration main menu is displayed.

1.34 Exceptions
EX 01 Operator has exceeded maximum number of login attempts
1. The system informs the operator that the maximum number of login attempts has been exceeded and that they must contact their site administrator to re-activate the account.
2. The operator acknowledges the message.
3. The system exits the logon window.

1.35 Issues
1. Should there be separate user id's for the various actors to limit their ability to access and modify information?
   TB 04/17/00: Yes separate user id's should exist. For example, a doctor and an analyst are separate users. But what about multiple accessibility? For example, a person who is both a doctor AND an analyst.
2. Should there be a set number of retries allowed before the operator is “kicked out”?
   TB 04/17/00: Yes, the specific number is to be determined.
   TB 05/05/00: Three to five tries before being kicked out. We could make this system administrator configurable.
3. Should the system record login information. For example, who logged in, when, for how long, etc.
   TB 04/17/00: This is a question for the customer.
   TB 05/05/00: Yes, events like this should be recorded, so they may be accessed later as an audit trail.
4. What if the operator is currently logged on to the system and logs in again from somewhere else? Should we allow multiple logons?
   TB 04/17/00: Multiple logons should be ok.
5. Should the operator be required to change their password every so often? If so, how often? Every 90 days? 180?
   TB 05/05/00: Yes they should be required to change their password. It should be configurable by the administrator.
6. How should guest users access be implemented. For example, how do you grant access to one or more patient's data to a friend or relative. Is a new login id created for each ‘guest’. Is one guest id created per patient and the patient tells the friend or relative the code? What if the patient wants to revoke access to a specific family member at a later date? Does the friend or relative view different/less information than the patient?
   TB 04/17/00: This is a question for the customer.
   TB 05/05/00: The patient MUST grant user access to their information. The patient must sign an authorization form granting access. The site administrator will grant access upon receiving the completed and signed authorization form. Each guest will have a separate user account for tracing purposes. The patient must also sign an authorization form to revoke guest access.

1.36 Non-Functional System Requirements
1. Security issues. Filter user id by IP address.

UC 02. Add a Group Level Configuration Template.

1.37 Use Case Diagram
None.

1.38 Purpose (Description)
The purpose of this use case is to create a configuration template for a group.

1.39 Actors
1. Caregiver.
2. Site administrator.

1.40 Preconditions (Assumptions)
1. The operator is logged on. [UC 01].
2. The group already exists. [UC 05].

1.41 Main Flow (Steps)
1. The operator chooses to create a configuration template for the selected group.
2. System presents a blank configuration template.
3. The operator enters basic configuration data.
4. The operator assigns dosage information.
5. The operator optionally assigns questionnaires. [SF 01: Assign questionnaire].
6. The operator optionally assigns alarms. [SF 02: Assign alarms].
7. The operator optionally assigns sounds. [SF 03: Assign sounds].
8. The operator enters a shape and color for each drug. [SF 04: Assign picture and color].
9. The operator enters medication information for patient information.
10. The operator saves the group configuration.
11. The system verifies that the data is valid. [EX 01 Invalid data entry].
12. The system confirms that the configuration has been saved to the database. [EX 02: Save operation fails.]
13. The operator acknowledges this confirmation.
14. The system continues to display the configuration information.
15. The operator chooses to apply the newly created configuration to the group.
16. The system asks if the operator wishes to apply the configuration to the first patient in the group.
17. The operator makes one of the following types of responses: yes, yes to all members, no, or cancel.
   a. If the operator selects yes then the questionnaire is applied to the patient and the next patient is displayed.
   b. If the operator selects yes to all then the questionnaire is applied to all of the patients in the group.
   c. If the operator selects no then the questionnaire is not applied to that patient and the next patient in the group is displayed.
   d. If the operator selects cancel then the questionnaire is not applied to that patient or any additional patients.

1.42 Sub Flow(s) (Variations)
SF 01: Assign questionnaire.
1. The operator chooses to assign one or more questionnaires to the group configuration template.
2. The system displays a summary of all currently assigned questionnaires (There are none initially).
3. The operator selects one or more questionnaires to assign.
4. The system returns to the updated summary of all currently assigned questionnaires for the group configuration template.
SF 02: Assign alarms.
1. The operator chooses to assign alarm information to the group configuration template.
2. The system displays a summary of all currently assigned alarms. (There are none initially.)
3. The operator adds one or more alarms to the configuration template.
4. The system displays alarm entry fields.
5. The operator enters data for the assigned alarms. (The operator may update or delete previously entered alarms.)
6. The system returns to the updated summary of all currently assigned alarms for the group configuration template.
SF 03: Assign sounds.
7. The operator chooses to assign sound information to the group configuration template.
8. The system displays a summary of all currently assigned sounds. (There are none initially).
9. The operator specifies a sound type to assign.
10. The system displays default values for frequency and duration of the sound.
11. The operator can optionally update the frequency or duration of the sound
12. The system returns to the updated summary of all currently entered sounds for the group configuration template.
SF 04: Assign picture and color.
1. The operator assigns a picture (shape) for the drug.
2. The operator selects a color for the drug.

1.43 Exceptions
EX 01 Invalid data entry.
1. The system informs the operator that the data entered is invalid or that the required information was not entered.
2. The operator acknowledges the message.
3. The system highlights the invalid or missing data fields.
4. The operator corrects or adds the data.
5. The operator chooses to re-save or cancel.
EX 01: Save operation fails.
1. The system is unable to save the data to the database.
2. The system informs the operator that the save has failed.
3. The operator acknowledges that the save has failed
4. The system continues to display all information previously entered by the operator.
5. The operator may re-save or cancel.

1.44 Issues
1. If a caregiver who is not the original prescriber of medication changes the configuration dose, send an email to the original caregiver.
   Future Functionality

1.45 Non-Functional System Requirements
None.

UC 03. View/Update Patient Information

1.46 Use Case Diagram
None.

1.47 Purpose
This use case describes the activities for an operator to view or update the data associated with an existing patient in the system.

1.48 Actors
1. Caregiver.
2. Site Administrator.
3. Caseworker. (View-only).
4. Analyst. (View-only).

1.49 Preconditions
1. The caregiver is logged on. [UC 01].
2. A valid patient exists. [UC 08].

1.50 Main Flow
1. The operator chooses to access the patient data and selects a specific patient.
2. The system displays the patient information.
3. The operator optionally updates patient data fields.
4. The operator saves the patient information.
5. The system verifies that the data is valid. [EX 01 Invalid data entry].
6. The system confirms that the data was saved. [EX 02: Save operation fails.]
7. The system continues to display the patient data.

1.51 Sub Flow(s)
None.

1.52 Exceptions
EX 01 Invalid data entry.
18. The system informs the operator that the data entered is invalid or that the required information was not entered.
19. The operator acknowledges the message.
20. The system highlights the invalid or missing data fields.
21. The operator corrects or adds the data.
22. The operator chooses to re-save or cancel.
EX 02: Save operation fails.
6. The system is unable to save the data.
7. The system informs the operator that the save has failed.
8. The operator acknowledges that the save has failed.
9. The system continues to display all information previously entered by the operator.
10. The operator may re-save or cancel.

1.53 Issues
None.

1.54 Non-Functional System Requirements
None.

UC 04. Summarize Patient Events.

1.55 Use Case Diagram
None.

1.56 Purpose (Description)
The purpose of this use case is to summarize the events that occurred for a given patient during specified periods of time.

1.57 Actors
1. Caregiver.
2. Site Administrator.

1.58 Preconditions (Assumptions)
1. The operator is currently logged on. [UC_{—}01].
2. The patient exists. [UC_{—}08].

1.59 Main Flow (Steps)
1. The operator chooses to summarize the events for a given patient during a specified period of time.
2. The operator specifies the patient.
3. The operator specifies a date range.
4. The system checks the date range to ensure that it specifies a valid range. [EX 01 Date range is invalid].
5. The system retrieves the event data about the patient for the specified date range.
6. The system displays a summary of the retrieved event data.

1.60 Sub Flow(s) (Variations)
None.

1.61 Exceptions
EX 01: Date range is invalid.
1. The system informs the operator that the date range is invalid.
2. The operator acknowledges message.
3. The operator corrects the date range.

1.62 Issues
1. How are events supposed to be summarized and displayed? By event type? Is this really meaningful? What is the operator looking for here? This is an issue with step 6.
   TB 05/10/00: Other potential types of reports:
      a. Drawer open events
      b. Expected vs actual
      c. Rank non-compliance
      d. Dose taken/doses prescribed
      e. Identify adverse drug effects
      f. “How do you feel today”
      g. Side affects vs adverse drug effects
      h. Non compliance by group/patient/drug **
      i. Compliance by date
      j. Date/Time missed/scheduled/taken.
      k. Questionnaire matrix report
      l. Enter a question and weigh answers?
      m. Canned reports for questionnaires?
      n. Patient is better/worse/stable
      o. What reports would you like everyday?
2. Should we allow the user to specify a range of days and/or a single day in their query instead of just everything?
   TB 04/17/00: Yes the user should be able to specify a day or range of days in their query.

1.63 Non-Functional System Requirements
None.

UC 05. Add a Group.

1.64 Use Case Diagram
None.

1.65 Purpose (Description)
The purpose of this use case is to add a new group to an existing site.

1.66 Actors
1. Site Administrator.

1.67 Preconditions (Assumptions)
1. The operator is currently logged on to the system. [US_{—}01].

1.68 Main Flow (Steps)
1. The operator chooses to add a new group to the site.
2. The system displays all of the group data entry fields.
3. The operator enters the data about the new group.
4. The operator optionally adds users/individuals to this group. [UC_{—}09].
5. The operator optionally assigns patients to the group.
6. The operator saves the group data.
7. The system verifies that the group data is valid. [EX 01: Data is invalid].
8. The system verifies that a duplicate group identifier or group name does not exist for that site. [EX 02 Duplicate group name].
9. The system saves the group information.
10. The system informs the operator that the group information has been saved. [EX 02: Save operation fails].
11. The system continues to display the newly entered group information entered by the operator.
12. The operator optionally assigns a configuration file to the group. [UC_{—}02].

1.69 Sub Flow(s) (Variations)
None.

1.70 Exceptions
EX 01: Data is invalid.
1. The system informs the operator that the data entered is invalid or incomplete.
2. The operator acknowledges the message.
3. The system highlights invalid or incomplete fields.
4. The operator corrects or adds the information.
5. The operator saves the group data or cancels entering the data.
EX 02: Duplicate group name.
1. The system informs the operator that the group name already exists for this site.
2. The operator acknowledges the message.
3. The system highlights the group name.
4. The operator changes the group name to a unique name.
5. The operator saves the group data or cancels entering the data.
EX 02: Save operation fails.
1. The system is unable to save the data.
2. The system informs the operator that the save has failed.
3. The operator acknowledges that the save has failed
4. The system continues to display all information previously entered by the operator.
5. The operator attempts to re-save the group data or cancels entering the data.

1.71 Issues
None.

1.72 Non-Functional System Requirements
None.

UC 06. View/Update a Patient Configuration.

1.73 Use Case Diagram
None.

1.74 Purpose (Description)
This use case is used to view or update a patient configuration. This would include modifying drawers and/or dosages, modifying alarms, or assigning existing questionnaires, or adding a new questionnaire.

1.75 Actors
3. Caregiver.
4. Site Administrator.
5. Analyst (View only).

1.76 Preconditions (Assumptions)
3. The operator is logged on. [UC 01].
4. The patient exists. [UC 08].
5. The configuration exists. [UC 02].

1.77 Main Flow (Steps)
1. The operator chooses to view or update a patient configuration.
2. The operator selects a patient.
3. The system displays the current patient configuration.
4. The operator optionally modifies the patient configuration data fields. If the operator has view only privileges, then the fields are displayed, but they are non-editable.
5. The operator optionally updates the configuration of the drawers or dosages. [SF 01: Update drawers/dosages].
6. The operator optionally updates the sound configuration. [SF 02: Update sound configuration].
7. The operator optionally updates alarm configuration. [SF 03: Update alarm configuration].
8. The operator optionally updates the questionnaire assignments. [SF 04: Assign questionnaires].
9. The operator saves the updated patient configuration. [SF 05: Operator cancels modifications].
10. The system saves the updated patient configuration. [EX 01 Save operation fails].
11. The operator optionally generates the patient configuration file to be used by the patient. [SF 06: Patient configuration generation].
12. The system continues to display the patient configuration with the updates entered by the operator.

1.78 Sub Flow(s) (Variations)
SF 01: Update drawers/dosages.
1. The operator chooses to update the drawers/dosages.
2. The system displays the current drawer and dosage configuration for the patient.
3. The operator makes modifications to the drawer and dosage configuration data.
SF 02: Update sound configuration.
1. The operator enters the update sound configuration screen.
2. The system displays the current sound configuration for the patient.
3. The operator makes modifications to the sound configuration data.
SF 03: Update alarm configurations.
1. The operator enters the update alarm configuration screen.
2. The system displays the current alarm configuration for the patient.
3. The operator makes modifications to the alarm configuration data.
SF 04: Assign questionnaires.
1. The operator enters a screen to assign questionnaires.
2. The system displays the current questionnaire assignment for the patient.
3. The operator assigns up to two new questionnaires.
SF 05: Operator cancels modifications.
1. The operator chooses to cancel all changes before saving.
2. The system is returned to its previous state (prior to the modifications).
SF 06: Patient configuration generation.
1. The operator generates the file for use by the patient's Med-eMonitor™
2. If the system determines that this is the first configuration file for this patient,
   a. The system prompts the user to accept the download of an abbreviated patient configuration file and to specify a target directory to place the file.
   b. The operator confirms the download and specifies a target directory.
   c. The system generates an abbreviated patient configuration file as well as the actual patient configuration file.
   d. The system sends the file to the directory specified by the operator.
3. The system generates the configuration file for the Med-eMonitor™ to retrieve at a pre-programmed time of day.

1.79 Exceptions
EX 01: Save operation fails.
11. The system is unable to save the data to the database.
12. The system informs the operator that the save ahas failed.
13. The operator acknowledges that the save has failed
14. The system continues to display all information previously entered by the operator.
15. The operator may attempt to save again or cancel the update.

1.80 Issues
1. How do we assign questionnaires? Should each new group have a “default” questionnaire assigned to it? That way, when patients are created and assigned to a group, they get the group's questionnaire. The caregiver may then tailor that configuration to the patient.
   CRB 4/19/00: This will be handled through the concept of templates.
2. Do we want to allow multiple patients to use the same configuration? Future use case? For example, what if 100 patients are all part of the same clinical trial and are on exactly the same protocol? There should be a way to assign the same configuration to all of them without having to recreate it.
   CRB 4/19/00: This will be handled through the concept of templates.
3. Do we need to distinguish between public/private questionnaires in this use case?
   CRB 4/19/00: There will be three levels of questionnaires: System, Group and Individual. System level questionnaires cannot be changed and can be assigned to anyone. Group level questionnaires cannot be changed and can be assigned to patients in that group. Individual questionnaires are only assigned to a single patient.
4. Will we ever need to delete a configuration? Or will it only be modified?

1.81 Non-Functional System Requirements
None.

UC 07. View/Update Questionnaires.

1.82 Use Case Diagram
None.

1.83 Purpose (Description)
The purpose of this use case is to provide the capability to view or update existing site and/or group level questionnaires.

1.84 Actors
1. Caregiver.
2. Site administrator.

1.85 Preconditions (Assumptions)
1. The questionnaire currently exists in the system. [UC 29].

1.86 Main Flow (Steps)
1. The operator chooses to view or update a questionnaire.
2. The operator selects a questionnaire to view.
3. The system retrieves the questionnaire.
4. The system displays the selected questionnaire to the operator. [SF 01: Display questionnaire].
5. The operator adds, updates or deletes question data. (Individual questionnaires only).
6. The operator adds, updates or deletes answer data. (Individual questionnaires only).
7. The operator saves the updated questionnaire.
8. The system ensures that the questionnaire has at least one question and that each question has at least two answers. [EX 01: Invalid questionnaire data].
9. The system saves the changes to the questionnaire. [EX 02: Save operation fails].

1.87 Sub Flow(s) (Variations)
SF 01: Display questionnaire.
1. If the questionnaire is at the site level or the group level, the questionnaire can only be viewed. It cannot be edited and saved.
2. If the questionnaire is an individual questionnaire, the questionnaire can be viewed, edited, and saved.

1.88 Exceptions
EX 01: Invalid questionnaire data.
1. The system determines that the questionnaire is not valid.
2. The system informs the operator that the questionnaire is invalid.
3. The operator acknowledges that the questionnaire is not valid.
4. The system continues to display the questionnaire for further editing.
5. The operator continues to edit the questionnaire or cancels entering the data.
EX 02: Save operation fails.
16. The system is unable to save the data to the database.
17. The system informs the operator that the save has failed.
18. The operator acknowledges that the save has failed.
19. The system continues to display all information previously entered by the operator.
20. The operator attempts to re-save the data or cancels entering the data.

1.89 Issues
1. Need to define Public vs. Private questionnaires.
   CRB 4/19/00: Questionnaires will be three levels: Site level, Group level and

Individual level. Site level questionnaires can be assigned to any patient. Group level questionnaires can be assigned to any patient within the group. Individual level questionnaires are assigned to a single patient.
How many public questionnaires can be defined? Currently only two can be defined. Why not more?
   CRB 4/18/00: Per Rob Betsil, An unlimited number of public and private questionnaires should be allowed by the system.
2. How/when can a questionnaire be deleted? Who can delete questionnaires?
   CRB 4/19/00: No questionnaires can be deleted at this time.
3. What is the process for changing a questionnaire that is currently being used?
   CRB 4/19/00: Site and group level questionnaires cannot be changed. Only individual level questionnaires can be changed.
4. For a study run a year ago, can you look up to see what questions were asked.
   CRB 4/19/00: This is a question for Rob Betsill. Sent email.

UC 08. Add a Patient.

1.90 Use Case Diagram
None.

1.91 Purpose (Description)
The purpose of this use case is to add a new patient to the Med-eMonitor™ system.

1.92 Actors
1. Caregiver.
2. Site Administrator.

1.93 Preconditions (Assumptions)
1. The caregiver is logged on. [UC 01].

1.94 Main Flow (Steps)
1. The operator chooses to add a patient.
2. The system determines which group name the operator is using.
3. The system displays a screen containing patient registration data fields along with the group name the operator is using.
4. The operator enters the patient's information.
5. The operator selects the option to save the patient information.
6. The system selects a unique patient number for the patient.
7. The system saves the patient information. [EX 01: Saving patient data fails]. [EX 02: Required fields not entered].
8. The system informs the operator that the save has successfully completed.
9. The patient registration screen is re-displayed with the system assigned patient number and all of the entered patient data.

1.95 Sub Flow(s) (Variations)
None.

1.96 Exceptions
EX 01: Saving patient data fails.
1. The system is unable to save the data.
2. The system informs the operator that the save has failed.
3. The operator acknowledges that the save has failed.
4. The system releases the unique patient number for the patient.
5. The patient registration screen is re-displayed with entered patient information. (The patient number is empty.)
EX 02: Required fields not entered.
1. The system is unable to save the data because the required fields are not completed.
2. The system informs the operator to complete the required fields.
3. The system highlights the incomplete required fields.
4. The operator acknowledges that the required fields were not complete.
5. The operator adds information to the incomplete fields.
6. The operator saves the patient information. [EX 01: Saving patient data fails]. [EX 02: Required fields not entered].
7. The system informs the operator that the save has successfully completed.
8. The patient registration screen is re-displayed with the system assigned patient number and all of the entered patient data.

1.97 Issues
1. What will the patient number look like? How many digits? Will it be alphanumeric? Will it scale for large numbers of patients?
   TLB, 04/20/00, Currently the patient number is alphanumeric and it is six digits.
   TLB, 05/10/00, It was recommended during a customer meeting to change the size of the patient number to 10 or 12 characters.
2. Can patients be added without an associated group? Do they have to be immediately assigned to a group?
   TLB, 05/10/00, A patient can be added without being immediately added to a group. However, a patient can only be ACTIVE in one group at a time. For historical reasons, the patient may belong in more than one group.

UC 09. Add New User Information.

1.98 Use Case Diagram
None.

1.99 Purpose (Description)
This use case describes the activities involved when an operator adds a new user (caregiver, caseworker, analyst) to the system.

1.100 Actors
1. Site Administrator.
2. Caregiver.

1.101 Preconditions (Assumptions)
1. The operator is logged on. [UC 01].

1.102 Main Flow (Steps)
1. The Caregiver chooses to add information for a new user. (A new user includes a caregiver, a caseworker, or an analyst).
2. The system displays user data fields.
3. The operator enters the user information including the type of user (caregiver, caseworker, or analyst).
4. The operator optionally associates the user with a group. A site administrator can assign the user to any group in the site. However, other actors can only assign the user to their own group or groups.
5. The operator saves the information. [SF 01: Operator cancels additions].
6. The user information is saved. [EX 01: Save operation fails].
7. The system informs the operator that the data has been saved.

1.103 Sub Flow(s) (Variations)
SF 01: Operator cancels additions.
3. The operator chooses to cancel adding the user before saving.
4. The system is returned to its previous state (prior to beginning this use case).

1.104 Exceptions
EX 01: Save operation fails.
1. The system is unable to save the data.
2. The system informs the operator that the save has failed.
3. The operator acknowledges that the save has failed.
4. The fields to enter a new user are re-displayed. The fields contain all entered information.

1.105 Issues
1. Will we allow caregivers to be added to the system without being associated to a group?
   Yes, we should. This will mean, however, that the user will in the system but unable to access anything until group assignment.
2. Where will the valid values for Caregiver Type be stored (i.e. Physician, Case worker, Nurse, etc.)? A new table may need to be added?
3. Is every user that the system stores data about going to have a user account (a login id and password)? If so, is this use case covered by security and the information that is set up when a user account is set up.
   No, should ask if they have access.

UC 10. Determine Dosage Compliance.

1.106 Use Case Diagram
None.

1.107 Purpose (Description)
The purpose of this use case is to determine the medicine dosage compliance of a patient for a specified period of time.

1.108 Actors
1. Caregiver
2. Family member
3. Patient
4. Caseworker
5. Analyst

1.109 Preconditions (Assumptions)
1. The operator is logged on to the system. [UC 01].
2. The patient exists within the system. [UC 08].

1.110 Main Flow (Steps)
1. The operator requests compliance information for a particular patient number and a specified period of time.
2. The system finds the information using the patient number, the specified date ranges, and the group associated with the operator. [EX 01: No information found.]
3. The data is formatted for the screen display.
4. The information is displayed. [SF 01: Print the screen.]
5. The operator closes the window when finished browsing the data.

1.111 Sub Flow(s) (Variations)
SF 01: Print the screen.
1. The operator requests a screen print.
2. The screen is printed.
3. The screen continues to be displayed.

1.112 Exceptions
EX 01: No information found.
1. The system locates no information for the given patient number, the operator's group, and the specified dates.
2. An error message is displayed to the operator indicating that the information cannot be found.
3. The operator acknowledges that no information was found.
4. The operator looks for another patient number or cancels.

1.113 Issues
1. How should compliance queries be handled? Per patient? Per medication? Per patient groups?
2. How do we handle large amounts of data? For example, thousands of patients?

UC 11. Log Off of the System.

1.114 Use Case Diagram
None.

1.115 Purpose (Description)
The purpose of this use case is to allow the operator to log off of the Med-eMonitor™ system.

1.116 Actors
14. Caregiver
15. Patient
16. Family member
17. HMO Caseworker
18. Analyst
19. System administrator
20. Site administrator

1.117 Preconditions (Assumptions)
The operator is currently logged on to the system. [UC 01].

1.118 Main Flow (Steps)
1. The operator selects the option to log off.
2. A prompt is displayed checking to make sure that the operator meant to log off.
3. The operator confirms that a log off was intended. [SF 01: Operator does not affirm logoff].
4. The system makes a request to determine if the operator wishes to close the browser.
5. The operator confirms that the browser should be closed. [SF 02: Operator does not close browser].
6. The browser is closed.

1.119 Sub Flow(s) (Variations)
SF 01: Operator does not confirm logoff.
1. The operator does not confirm the logoff.
2. Control returns to the screen prior to the logoff request.
SF 02: Operator does not close browser.
1. The operator requests that the browser remains open.
2. The browser remains open and the Logon screen is displayed.

1.120 Exceptions
None.

1.121 Issues
1. For security reasons, should the browser be closed when logging out?
   04/17/00, TBD.
   05/05/00 Yes. Iteration 2.
2. Should there be an automatic logout after a certain period of inactivity?
   04/17/00, TBD, Doesn't seem to be needed immediately. How much time should pass before the automatic logout occurs? What should we do when the auto logout occurs? What do we do with changes that may not have been saved yet?
   05/05/00 Yes, we probably should implement some form of auto logout, however it should be addressed during. Increment 2.
3. For security reasons, should we ensure that the browser does no caching?
   04/17/00, TBD.
   05/05/00, Yes, we should ensure that no caching occurs by the client's browser. This will degrade performance some, but security is more of a concern.

UC 12. Retrieve Event Details.

1.122 Use Case Diagram
None.

1.123 Purpose (Description)
The purpose of this use case is to retrieve the details about specific events which have occurred for a given upload date/time. The events would contain detailed information and would be separated into 4 categories. These categories would consist of general events, questionnaire events, drawer events, and alarm events.

1.124 Actors
1. Caregiver.
2. Patient.
3. Family member. (View certain events only).
4. Analyst.
5. Caseworker.

1.125 Preconditions (Assumptions)
1. Operator is logged on to the system. [UC 01].
2. Patient must exist in the system. [UC 08].

1.126 Main Flow (Steps)
1. The operator wishes to see event details for a particular day after retrieving an event summary.
2. The operator selects the day of the event summary to get event details.
3. The system retrieves the details of the events.
4. The system determines which events are accessible to the operator.
5. The system determines whether each event is a general event, a questionnaire event, a drawer event, or an alarm event.
6. It displays the event information in up to four separate categories to the operator.
7. The operator closes the screen when finished reviewing the information.
8. Control returns back to the event-reporting screen.

1.127 Sub Flow(s) (Variations)
None.

1.128 Exceptions
None.

1.129 Issues
1. What about searching for particular events?
2. What about getting all events dealing with X over an operator specified date interval?
3. How are permissions to event details supposed to be handled? Who assigns these permissions? Where?

UC 13. Archive a Patient.

1.130 Use Case Diagram
None.

1.131 Purpose (Description)
This use case describes the activities involved when an operator archives an existing patient record.

1.132 Actors
1. Caregiver.
2. Site Administrator.

1.133 Preconditions (Assumptions)
1. The operator is logged on. [UC 01].
2. The patient record exists. [UC 08].

1.134 Main Flow (Steps)
1. The operator selects an existing patient to be archived.
2. The system displays the information about that patient.
3. The operator verifies that this is the correct patient to archive.
4. The operator archives the patient.
5. The system asks the operator to confirm that the patient should be archived.
6. The operator confirms that the patient should be archived. [SF 01: Operator cancels archive request].
7. The system archives the patient. [EX 01: Archive fails].

1.135 Sub Flow(s) (Variations)
SF 01: Operator cancels archive request.
1. The operator does not confirm the archive.
2. The system is returned to its previous state (prior to the archive request).

1.136 Exceptions
EX 01: Archive fails.
1. The system is unable to archive the patient.
2. The system notifies the operator that it was unable to archive the patient.
3. The operator acknowledges the failure.
4. The operator attempts to archive the patient again or cancels.

1.137 Issues
1. Will associated configurations be archived? What about the patient's association with their groups?
   TLB, 05/10/00, Yes we need to archive all the information about that patient for historical purposes.

1.138 Non-Functional System Requirements
None.

UC 14. Archive User Information.

1.139 Use Case Diagram
None.

1.140 Purpose (Description)
This use case describes the activities involved when an actor archives an existing user (caregiver, caseworker, analyst).

1.141 Actors
1. Site administrator.
2. Caregiver.

1.142 Preconditions (Assumptions)
1. The operator is logged on. [UC 01].
2. The user exists. [UC 09].

1.143 Main Flow (Steps)
1. The operator selects the user to be archived.
2. The system displays the information about that user.
3. The operator verifies that this is the correct user to archive.
4. The operator archives the user.
5. The system asks the operator to confirm that the user should be archived.
6. The operator confirms that the user should be archived. [S1: Operator does not confirm archive].
7. The system archives the user. [EX 01: Archive fails].

1.144 Sub Flow(s) (Variations)
S1: Operator does not confirm the archive.
1. The operator does not confirm archive.
2. The system is returned to its previous state (prior to the archive request).

1.145 Exceptions
EX 01: Archive fails.
5. The system is unable to archive the user.
6. The system notifies the operator that it was unable to archive the user.
7. The operator acknowledges the failure.
8. The operator attempts to archive the user again or cancels.

1.146 Issues
1. What about group associations?
   TLB, 05/10/00, Group associations need to be archived as well.

1.147 Non-Functional System Requirements
None.

UC 15. View/Update User Information.

1.148 Use Case Diagram
None.

1.149 Purpose (Description)
This use case describes the activities involved when user (caregiver, caseworker, analyst) information is viewed and/or updated.

1.150 Actors
3. Site administrator.
4. Caregiver.
5. Caseworker (View only).
6. Analyst (View only).

1.151 Preconditions (Assumptions)
2. The operator is logged on. [UC 01].
3. The user record exists. [UC 09].

1.152 Main Flow (Steps)
8. The operator selects a user to be viewed or updated.
9. The system verifies that the operator is a site administrator or is the individual whose record is being modified. For example, caregivers can only modify their own records. Site Administrators can modify all user records for that site. [SF 01: No authorization].
10. The system determines if the user can update information or just view information.
11. The system displays the information about the specified user. If the information is view only then the fields are displayed but they are non-editable. Viewers cannot see a patient's SSN. Caregiver and Site Administrator can view/update SSN.
12. The operator makes modifications to any modifiable fields as desired.
13. The operator saves the user information. [SF 02: Operator cancels modifications.]
14. The system updates and saves the user information. [EX 01: Save operation fails].
15. The system continues to display the user information that the operator had edited.

1.153 Sub Flow(s) (Variations)
SF 01: No authorization.
1. The system determines that the operator is not allowed to view the selected user information.
2. The system notifies the operator that access to the information is not allowed.
3. The system allows the operator to select a new user to view or update.
SF 02: Operator cancels modifications.
5. The operator chooses to cancel all changes before saving.
6. The system is returned to its previous state (prior to the modifications).

1.154 Exceptions
EX 01: Save operation fails.
21. The system is unable to save the data to the database.
22. The system informs the operator that the save has failed.
23. The operator acknowledges that the save has failed.
24. The system continues to display all information previously entered by the operator.
25. The operator may re-save or cancel.

1.155 Issues
2. Can only the individual user change their user information? Who can view this information? Do site/group/patient permissions apply?
   Site Admin only.

1.156 Non-Functional System Requirements
None.

UC 16. Archive a Group.

1.157 Use Case Diagram
None.

1.158 Purpose (Description)
This use case describes the activities involved when an operator archives an existing group.

1.159 Actors
1. Site Administrator.

1.160 Preconditions (Assumptions)
16. The operator is logged on. [UC 01].
17. The group exists. [UC 05].

1.161 Main Flow (Steps)
1. The operator selects an existing group to be archived.
2. The system displays all information about that group.
3. The operator verifies that this is the correct record to archive.
4. The operator archives the selected group.
5. The system asks the operator to confirm that the group should be archived.
6. The operator confirms that the group should be archived. [SF 01: Operator cancels archive request].
7. The system verifies that the group has no users associated with it. [SF 02: Group has associated caregivers].
8. The system archives the group. [EX 01: Archive fails].

1.162 Sub Flow(s) (Variations)
S1: Operator cancels archive request.
7. The operator does not confirm the archive.
8. The system does not archive the group.
9. The system is returned to its previous state (prior to the archive request).
S2: Group has associated caregivers.
1. The system warns the operator that the group cannot be archived until all associated caregivers have been archived.
2. The system is returned to its previous state (prior to the archive request).

1.163 Exceptions
EX 01: Archive fails.
1. The system is unable to archive the group.
2. The system notifies the operator that it was unable to archive the group.
3. The operator acknowledges the failure.
4. The operator attempts to archive the group again or cancels.

1.164 Issues
1. Should operators be prevented from archiving a group that has existing members? Should they be forced to archive all members from a group before archiving the group? Should they simply be warned that if they archive the group, all associated members will be archived. What if a group contains a doctor and that doctor has a patient. If the group is archived is the doctor also archived? Does the patient then remain with no associated doctor?

1.165 Non-Functional System Requirements
None.

UC 17. View/Update a Group.

1.166 Use Case Diagram
None.

1.167 Purpose (Description)
The purpose of this use case is to display or change information for an existing group.

1.168 Actors
1. Site Administrator.
2. Caregiver.
3. Analyst (View only).
4. Caseworkers (View only).

1.169 Preconditions (Assumptions)
1. The operator is currently logged on. [UC 01].
2. The group exists. [UC 05].
3. The operator has appropriate rights to view the group.

1.170 Main Flow (Steps)
1. Operator chooses to access group information and selects a group to view or update.
2. The system retrieves the group's data.
3. The system displays the group information. If the operator has view only privileges, then the fields are displayed but they are non-editable.
4. The operator optionally updates the group data fields.
5. The operator optionally adds users to this group. [UC 09].
6. The operator saves the group information. [SF 01: Operator cancels modifications].
7. The system saves the group information. [EX 01: Save operation fails].
8. The system continues to display the group information with all changes entered by the operator.

1.171 Sub Flow(s) (Variations)
SF 01: Operator cancels modifications.
10. The operator chooses to cancel all changes before saving.
11. The system is returned to its previous state (prior to the modifications).

1.172 Exceptions
EX 01: Save operation fails.
26. The system is unable to save the data.
27. The system informs the operator that the save has failed.
28. The operator acknowledges that the save has failed.
29. The system continues to display all information previously entered by the operator.
30. The operator may attempt to save again or cancel the update.

1.173 Issues
None.

1.174 Non-Functional System Requirements
None.

UC 18. Add a Valid Value.

1.175 Use Case Diagram
None.

1.176 Purpose (Description)
This use case describes the steps involved in adding a new valid value to the system.

1.177 Actors
1. System administrator
2. Site administrator

1.178 Preconditions (Assumptions)
None.

1.179 Main Flow (Steps)
1. The operator chooses to add a new valid value to the system.
2. The system displays the currently available valid value categories
3. The operator selects a valid value category. [SF 01: Category does not exist].
4. The system displays the currently available valid values.
5. The operator chooses to add a new valid value.
6. The system displays the entry fields for the valid value.
7. The operator enters the valid value data.
8. The operator chooses to save the entry to the database.
9. The system verifies that the entry is not a duplicate. [EX 01: Duplicate valid value]
10. The system saves the entry to the database. [EX 02: Save operation fails.]
11. The system continues to display the data entered by the operator.

1.180 Sub Flow(s) (Variations)
SF 01: Category does not exist
1. The operator chooses to add the valid value category.
2. The system displays the entry fields for the valid value category.
3. The operator enters the valid value category data.
4. The operator chooses to save the data.
5. The system verifies that the entry is not a duplicate. [EX 02 Duplicate valid value category.]
6. The system saves the entry to the database. [EX 03: Save operation fails.]
7. The system continues to display the data entered by the operator.
SF 02: Valid value category already exists.
1. The operator may choose to add a new value to this category.
2. The operator enters the valid value data.
3. The operator chooses to save this new value.
4. The system saves the data to the database [EX 01: Save operation fails.]
5. The system continues to display the data entered by the operator.

1.181 Exceptions
EX 01: Duplicate valid value.
1. The system informs the operator that the valid value already exists.
2. The operator acknowledges this message.
3. The system returns to the previous state and continues to display the information entered by the operator.
EX 02: Duplicate valid value category.
4. The system informs the operator that the valid value category already exists.
5. The operator acknowledges this message.
6. The system returns to the previous state and continues to display the information entered by the operator.
EX 03: Save operation fails.
31. The system is unable to save the data to the database.
32. The system information the operator that the save has failed.
33. The operator acknowledges that the save has failed
34. The system continues to display all information previously entered by the operator.
35. The operator may re-save or cancel.

1.182 Issues
1. This may be included in future functionality.

1.183 Non-Functional System Requirements
None.

UC 19. View/Update a valid value.

1.184 Use Case Diagram
None.

1.185 Purpose (Description)
This use case describes the steps involved in viewing/updating valid values in the system.

1.186 Actors
3. Site administrator
4. System administrator

1.187 Preconditions (Assumptions)
1. Valid value category exists.
2. Valid value exists.

1.188 Main Flow (Steps)
12. The operator chooses to view or update a valid value.
13. The system displays the currently available valid value categories.
14. The operator selects the valid value category.
15. The system displays all valid values for this category.
16. The operator may modify the data for a valid value.
17. The operator chooses to save the modifications.
18. The system saves the changes to the database. [EX 01: Save operation fails.]
19. The system continues to display the data entered by the operator.

1.189 Sub Flow(s) (Variations)
None.

1.190 Exceptions
EX 01: Save operation fails.
36. The system is unable to save the data to the database.
37. The system informs the operator that the save has failed.
38. The operator acknowledges that the save has failed
39. The system continues to display all information previously entered by the operator.
40. The operator may re-save or cancel.

1.191 Issues
1. This may be included in future functionality.

1.192 Non-Functional System Requirements
None.

UC 20. Delete a Valid Value.

1.193 Use Case Diagram
None.

1.194 Purpose (Description)
This use case describes the steps involved in deleting valid values from the system.

1.195 Actors
5. Site administrator
6. System administrator

1.196 Preconditions (Assumptions)
1. Valid value category exists.
2. Valid value exists.

1.197 Main Flow (Steps)
20. The operator chooses to delete a valid value.
21. The system displays the currently available valid value categories.
22. The operator selects the valid value category.
23. The operator chooses to view all valid values for this category. [SF 01: Delete valid value category.]
24. The system displays all valid values for this category.
25. The operator selects one or more valid values and chooses to delete.
26. The system provides an “Are you sure” warning.
27. The operator verifies the deletion [EX 01: Operator cancels deletion.]
28. The system deletes the data from the database.

1.198 Sub Flow(s) (Variations)
SF 01: Delete valid value category
1. Operator chooses to delete entire category
2. The system provides an “Are you sure” warning.
3. The operator verifies the deletion [EX 02: Operator cancels deletion.]
4. The system deletes the data from the database.

1.199 Exceptions
EX 01: Save operation fails.
41. The system is unable to save the data to the database.
42. The system informs the operator that the save has failed.
43. The operator acknowledges that the save has failed
44. The system continues to display all information previously entered by the operator.
45. The operator may re-save or cancel.
EX 02: Operator cancels deletion.
1. The operator chooses to cancel the deletion.
2. The system continues to display all information displayed prior to the deletion request

1.200 Issues
1. This may be included in future functionality.

1.201 Non-Functional System Requirements
None.

UC 21. Add a New User Account to the System.

1.202 Use Case Diagram
None.

1.203 Purpose (Description)
The purpose of this use case is to allow an administrator to add a new user account so that the operator may log in to the system and access groups.

1.204 Actors
1. System Administrator.
2. Site Administrator.

1.205 Preconditions (Assumptions)
1. The operator is logged in. [UC 01].

1.206 Main Flow (Steps)
1. From the Administration main menu, the operator selects security administration.
2. The system retrieves a list of all current user accounts and the groups they may access.
3. The system places asterisks in the password field to ensure that the administrator cannot see user passwords.
4. The system displays the data to the operator.
5. The administrator selects to add a new user account.
6. The administrator adds the user id, a default password, and the groups they may access.
7. The administrator saves the new user account. [EX 01: User account already exists].
8. The system saves the user account data. [EX 02: Save fails].
9. The user account list on the display is updated with the new user account.

1.207 Sub Flow(s) (Variations)
None.

1.208 Exceptions
EX 01: User account already exists.
1. The system determines that the user account already exists in the system.
2. The system notifies the administrator that the user account already exists.
3. The administrator acknowledges the notification.
4. The user list is redisplayed with no updates.
EX 02: Save fails.
1 The system is unable to save the data to the database.
2 The system informs the operator that the save has failed.
3 The operator acknowledges the notification.
4 The user account list is redisplayed with no updates.

1.209 Issues
None.

1.210 Non-Functional System Requirements
None.

UC 22. View/Update an Existing User Account.

1.211 Use Case Diagram
None.

1.212 Purpose (Description)
The purpose of this use case is to allow an administrator to view and update existing system user accounts.

1.213 Actors
1. System Administrator.
2. Site Administrator.

1.214 Preconditions (Assumptions)
1. The operator is logged in. [UC 01].

1.215 Main Flow (Steps)
1. From the Site Administration main menu, the operator selects security administration.
2. The system retrieves a list of all current user accounts and the groups they may access.
3. The system places asterisks in the password field to ensure that the administrator can not see user passwords.
4. The system displays the data to the operator.
5. The administrator makes modifications to the user account(s) as needed.
6. The administrator saves the changes.
7. The system asks if the administrator is sure that the changes should be saved.
8. The administrator confirms that the changes should be saved. [SF 01: Administrator cancels save].
9. The system saves the changes. [EX 01: Save fails].
10. Asterisks are substituted for the password if the password was changed.
11. The user account list is redisplayed with the updates.

1.216 Sub Flow(s) (Variations)
SF 01: Administrator cancels save.
1. The administrator does not confirm that the changes should be saved.
2. The system does not save the changes.
3. The user list is redisplayed with no updates.

1.217 Exceptions
EX 01: Save fails.
5 The system is unable to save the data to the database.
6 The system informs the operator that the save has failed.
7 The operator acknowledges the notification.
8 The user account list is redisplayed with no updates.

1.218 Issues
None.

1.219 Non-Functional System Requirements
None.

UC 23. Deactivate a System User Account.

1.220 Use Case Diagram
None. 1.221 Purpose (Description)
The purpose of this use case is to allow an administrator to deactivate active system user accounts.

1.222 Actors
1. System administrator.
2. Site administrator.

1.223 Preconditions (Assumptions)
1. Operator is logged on as a System Administrator or a Site Administrator. [UC 01].

1.224 Main Flow (Steps)
1. From the Site Administration main menu, the operator selects security administration.
2. The system retrieves a list of all current user accounts and the groups they may access.
3. The system places asterisks in the password field to ensure that the administrator cannot see user passwords.
4. The system displays the data to the operator.
5. The administrator deactivates the existing user account.
6. The system asks the administrator to confirm that the user account should be deactivated.
7. The administrator confirms that the user account should be deactivated. [SF 01: Administrator cancels deactivation].
8. The system deactivates the user account so that it may no longer be used. [EX 01: Deactivation fails].
9. The system redisplays the current user account list. The deactivated user account is no longer visible.

1.225 Sub Flow(s) (Variations)
SF 01: Administrator cancels deactivation.
1. The administrator does not confirm that the user account should be deactivated.
2. The system does not deactivate the user account.
3. The system redisplays the user account list. No user accounts are deactivated.

1.226 Exceptions
EX 01: Deactivation fails.
5. The system is unable to deactivate the user account.
6. The system informs the administrator that the deactivate has failed.
7. The administrator acknowledges the notification.
8. The system redisplays the user account list. No user accounts are deactivated.

1.227 Issues
1. What is the procedure/process for reusing old user accounts? How often can they be reused, if ever?

1.228 Non-Functional System Requirements
None.

UC 24. Add a Sponsor.

1.229 Use Case Diagram
None.

1.230 Purpose (Description)
This use case allows operators to add new sponsors to the system.

1.231 Actors
1. Site Administrator.

1.232 Preconditions (Assumptions)
1. Operator is currently logged on to the system. [UC 01].
2. Operator has access rights to add a group.

1.233 Main Flow (Steps)
1. The operator selects to add a sponsor.
2. The system displays a screen to accept sponsor data inputs.
3. The operator enters the new sponsor data.
4. The operator saves the sponsor data.
5. The system saves the new sponsor data. [EX 01: Save operation fails.]
6. The system notifies the operator that the sponsor data has been saved.
7. The operator acknowledges that the data was saved.
8. The sponsor information is displayed with the latest sponsor added.

1.234 Sub Flow(s) (Variations)
None.

1.235 Exceptions
EX 01: Save operation fails.
46. The system is unable to save the data to the database.
47. The system informs the operator that the save has failed.
48. The operator acknowledges that the save has failed
49. The system continues to display all information previously entered by the operator.
50. The operator may attempt to re-save the information or cancel adding a sponsor.

1.236 Issues
1. What exactly is a sponsor? Is Sponsor information the same as the group information? This is a question for the customer.
2. Should this use case be a sub-flow of UC 05?

1.237 Non-Functional System Requirements
None.

UC 25. View/Update a Sponsor.

1.238 Use Case Diagram
None.

1.239 Purpose (Description)
The purpose of this use case is to allow an operator to view and update existing sponsors.

1.240 Actors
3. Site Administrator.
4. Caregiver.
5. Analyst (View only).
6. Caseworkers (View only).

1.241 Preconditions (Assumptions)
1. Operator is logged on. [UC 01].
2. Valid sponsor exists. [UC 24].

1.242 Main Flow (Steps)
12. The operator chooses to view or update a sponsor.
13. The system displays a list of valid sponsors.
14. The operator selects the sponsor to view or update.
15. The system retrieves the sponsor's information.
16. The system displays the sponsor information to the operator. If the operator has view only privileges, then the fields are displayed, but they are non-editable.
17. The operator optionally updates the sponsor data fields.
18. The operator saves the sponsor information. [SF 01: Operator cancels modifications].
19. The system saves the changes to the database. [EX 01: Save operation fails].
20. The system re-displays the data that the operator entered.

1.243 Sub Flow(s) (Variations)
SF 01: Operator cancels modifications.
12. The operator chooses to cancel all changes before saving.
13. The system is returned to its previous state (prior to the modifications).

1.244 Exceptions
EX 01: Save fails.
1 The system is unable to save the data to the database.
2 The system informs the operator that the save has failed.
3 The operator acknowledges that the save has failed.
4 The system re-displays the sponsor information with the updates.

1.245 Issues
1. What exactly is a sponsor? Is Sponsor information the same as the Sponsor information? This is a question for the customer.
2. Should this use case be a sub-flow of UC 17?

1.246 Non-Functional System Requirements
None.

UC 26. Archive Sponsor Information.

1.247 Use Case Diagram
None.

1.248 Purpose (Description)
The purpose of this use case is to allow an administrator to archive an existing sponsor.

1.249 Actors
3. Site administrator.

1.250 Preconditions (Assumptions)
1. Operator is logged on. [UC 01].
2. The sponsor exists. [UC 24].

1.251 Main Flow (Steps)
10. The operator selects an existing sponsor to be archived.
11. The system retrieves the sponsor information.
12. The system displays the sponsor information to the operator.
13. The operator archives the sponsor.
14. The system asks the operator to confirm this archive.
15. The operator confirms that the sponsor should be archived. [SF 01: Operator cancels archive request].
16. The system archives the data from the database. [EX 01: Archive operation fails].
17. The sponsor list is redisplayed.

1.252 Sub Flow(s) (Variations)
SF 01: Operator cancels archive request.
4. The operator does not affirm that the sponsor should be archived.
5. The system does not archive the sponsor.
6. The system re-displays the sponsor list with no updates.

1.253 Exceptions
EX 01: Archive operation fails.
9. The system is unable to archive the operator.
10. The system informs the operator that the archive has failed.
11. The operator acknowledges the notification.
12. The system re-displays the sponsor list with no updates.

1.254 Issues
1. What exactly is a sponsor? Is Sponsor information the same as the Sponsor information? This is a question for the customer.

1.255 Non-Functional System Requirements
None.

UC 27. View/update Site Information.

1.256 Use Case Diagram
None.

1.257 Purpose (Description)
The purpose of this use case is to allow an administrator to view and update existing site information.

1.258 Actors
7. System Administrator.
8. Site Administrator. (Site of responsibility access only.)

1.259 Preconditions (Assumptions)
1. Operator is logged on. [UC 01].
2. A valid site already exists. [UC does not currently exist!].

1.260 Main Flow (Steps)
21. The operator chooses to view or update a site.
22. The system displays a list of valid sites (for Site Administrators, only their site of responsibility is displayed).
23. The operator selects the site to view or update.
24. The system displays the site information to the operator.
25. The operator optionally updates the site data fields.
26. The operator saves the site information. [SF 01: Operator cancels modifications].
27. The system saves the site information. [EX 01: Save operation fails].
28. The system re-displays the data that the operator entered.

1.261 Sub Flow(s) (Variations)
SF 01: Operator cancels modifications.
14. The operator chooses to cancel all changes before saving.
15. The system is returned to its previous state (prior to the modifications).

1.262 Exceptions
EX 01: Save operation fails.
51. The system is unable to save the data.
52. The system informs the operator that the save has failed.
53. The operator acknowledges that the save has failed.
54. The system continues to display all information previously entered by the operator.
55. The operator may attempt to save again or cancel the update.

1.263 Issues
1. No use case exists to create the site.

1.264 Non-Functional System Requirements
None.

UC 28. Assign a User to a Group.

1.265 Use Case Diagram
None.

1.266 Purpose (Description)
The purpose of this use case is to describe the actions involved in assigning a user (caregiver, analyst or caseworker) to a group.

1.267 Actors
1. Site administrator.
2. Caregiver.

1.268 Preconditions (Assumptions)
1. The operator must be logged on. [UC 01].
2. The user must exist. [UC 09].
3. The group must exist. [UC 05].

1.269 Main Flow (Steps)
1. The operator selects a group.
2. The system retrieves data for that group. [EX 01: Load operation fails].
3. The system displays the data about that group.
4. The operator selects a user.
5. The system retrieves the data about that user. [EX 01: Load operation fails].
6. The system displays the data about that user.
7. The operator requests that the system adds the user to the group.
8. The system saves the group/user assignment.
9. The system informs the operator that the information has been saved [EX 02: Save operation fails].

1.270 Sub Flow(s) (Variations)
None.

1.271 Exceptions
EX 01: Load operation fails.
1. The system does not find information for the requested item.
2. The system notifies the operator that the item was not found.
3. The operator must select another item.
EX 02: Save operation fails.
56. The system is unable to save the data to the database.
57. The system informs the operator that the save has failed.
58. The operator acknowledges that the save has failed
59. The system continues to display all information previously entered by the operator.
60. The operator may re-save or cancel.

1.272 Issues
1. Can any other actors assign users to groups? For example, caregivers can create new users, but they cannot assign the new user to a group?
   TLB, 05/09/00, Caregivers can assign users.

1.273 Non-Functional System Requirements
None.

UC 29. Add a Questionnaire.

1.274 Use Case Diagram
None.

1.275 Purpose (Description)
The purpose of this use case is to provide the capability to create a new questionnaire.

1.276 Actors
3. Caregiver. (May create Group or Individual level questionnaires only.)
4. Site administrator. (May create Site, Group or Individual level questionnaires.)

1.277 Preconditions (Assumptions)
1. The operator is logged on. [UC 01].

1.278 Main Flow (Steps)
10. The operator adds a new questionnaire.
11. The operator specifies the site, the group or the patient that is associated with the questionnaire.
12. The operator adds a question to the questionnaire
13. The operator adds the answers to the question.
14. The operator continues to add questions and answers to the questionnaire until the questionnaire is complete.
15. The operator requests to save the questionnaire.
16. The system responds by asking for a questionnaire name and a questionnaire level.
17. The system provides a list of currently used questionnaire names for that questionnaire level.
18. The operator supplies a name to call the questionnaire.
19. The system verifies that the questionnaire name is unique for that questionnaire level. [SF 01: Name not unique.]
20. The system saves the questionnaire. [EX 01: Save operation fails.]

1.279 Sub Flow(s) (Variations)
SF 01: Name not unique.
1. The system tells the operator that the questionnaire name is already in use.
2. The system provides re-displays the list of currently used questionnaire names.
3. The operator provides a different questionnaire name.
4. The system verifies that the questionnaire name is unique for that questionnaire level. [SF 01: Name not unique.]
5. The system saves the questionnaire. [EX 01: Save operation fails.]

1.280 Exceptions
EX 01: Save operation fails.
61. The system is unable to save the data to the database.
62. The system informs the operator that the save has failed.
63. The operator acknowledges that the save has failed.
64. The system continues to display all of the information previously entered by the operator.
65. The operator attempts to resave or cancel the updates.

1.281 Issues
5. Do we really need to specify what kind of questionnaire we are creating before we make it? We should be able to create a questionnaire and THEN designate whether it will be a site, group, or individual questionnaire. Right?
6. Need to define Public vs. Private questionnaires.
   CRB 4/19/00: Questionnaires could be three levels: Site level, Group level and

Individual level. Site level questionnaires can be assigned to any patient. Group level questionnaires can be assigned to any patient within the group. Individual level questionnaires are assigned to a single patient.
How many public questionnaires can be defined? Currently only two can be defined. Why not more?
   CRB 4/18/00: Per Rob Betsill, An unlimited number of public and private questionnaires should be allowed by the system.
7. How/when can a questionnaire be deleted? Who can delete questionnaires?
   CRB 4/19/00: There are issues with deleting public questionnaires. No questionnaires can be deleted at this time.
8. What is the process for changing a questionnaire that is currently being used?
   CRB 4/19/00: Site and group level questionnaires cannot be changed. Only individual level questionnaires can be changed.
9. For a study run a year ago, can you look up to see what questions were asked.
   CRB 4/19/00: This is a question for Rob Betsill. Sent email. Per Rob, this data is stored in the database. There is not currently a GUI to display it.

UC 30. Import Patient Events.

1.282 Use Case Diagram
None.

1.283 Purpose (Description)
The purpose of this use case is to provide the capability to import a patient event file.

1.284 Actors
1. System Timer.

1.285 Preconditions (Assumptions)
1. The event file the system reads has been created by the Med-eMonitor™, and is located in the proper directory.

1.286 Main Flow (Steps)
21. The system initiates a timer to execute at a configurable period of time.
22. When the System Timer expires, it checks a configurable directory to collect any patient event files that have been created.
23. The System Timer collects all of the files.
24. The System Timer parses all of the files.
25. The System Timer saves the data from the parsed files. [EX 01: Save operation fails.]
26. The System Timer deletes the event files from the directory.
27. The System Timer is reset to expire at the next configured period.

1.287 Sub Flow(s) (Variations)
None.

1.288 Exceptions
EX 01: Save operation fails.
66. The system is unable to save the data to the database.
67. The system logs the event that it was unable to store this information.
68. The system releases the files and does not delete them from the directory so it may re-attempt saving the information the next time the timer expires.

1.289 Issues

1. A method of monitoring a treatment of a patient with a medication, the method comprising:
implementing a data processing apparatus for defining a medical treatment plan as a template which contains a plurality of data elements and storing the template in a database that is linked through a communications network to at least one remote monitoring device, the medical treatment plan describing a treatment of a group comprised of two or more patients with the medication;
transmitting the medical treatment plan to the monitoring device over the network, and obtaining patient response data supplied by the patient in response to the data elements, the patient response data relating at least in part to a record of the intake of the medication by the patient; and
providing a report of said patient response data for a selected range of dates comprising one or more days.

2. A method in accordance with claim 1, wherein the report relates to data for an individual patient.

3. A method in accordance with claim 1, wherein the report relates to data for a group of patients.

4. A method in accordance with claim 1, wherein the report includes patient response data that is correlated with additional data relating to one or more patient outcomes, to determine the relationship between the medication intake by the patient and the patient outcomes.

5. A method in accordance with claim 1, wherein the step of correlating the patient data with additional data comprises:
combining the patient data with the additional data; and
performing data mining and statistical analysis of the combined data; and providing a report of said analysis.

6. A method in accordance with claim 1, further comprising the step of using the reported correlation between the patient response data and the additional data to adjust the recommended dosing instructions for the medication.

7. A method in accordance with claim 4, further comprising the step of using the reported correlation between the patient response data and the additional data to adjust the recommended dosing instructions for the medication.

8. A method in accordance with claim 5, further comprising the act of using the reported correlation between the patient response data and the additional data to adjust the recommended dosing instructions for the medication.

9. A method in accordance with claim 1, wherein the patient response data relate to at least one of:
patient compliance to intake of the medication;
patient's answers to one or more health status questions;
patient's answers to one or more quality of life questionnaires;
patient physiologic data; and
patient laboratory data.

10. A method in accordance with claim 1, wherein the additional data comprise at least one of:
patient genomic data, patient proteomic data, patient phenotypic data, patient economic data, and patient healthcare data; and
wherein the additional data relate to at least one of:
a medication side effect;
the patient's health status;
the patient's quality of life;
the patient's physiologic status:
the patient's genotype;
a resulting value of a laboratory test performed on the patient;
a serum protein;
a cell surface receptor;
an economic cost of medication treatment; and
an interaction between two or more drugs.

11. A method in accordance with claim 4, further comprising the step of updating one or more of the patient medical treatment plans, in response to the report.

12. A method in accordance with claim 1, wherein the data elements stored in the database relate to at least one of:
instructions relating to the medication;
medical educational content regarding the medication;
intake dosage for the medication;
physiological measurement of the patient;
one or more cell surface receptors;
one or more serum proteins;
DNA data;
protein data;
psychological measurement of the patient,
instructions or medical education content related to a disease state or a medical condition of the patient;
a pathogen or a class of pathogen;
instructions or medical educational content related to a viral infection, or upon a specific viral disease such as HIV/AIDS, hepatitis A, B, C, D, E or G;
instructions or medical educational relating to one of a bacterial disease agent and a microbial agent; and
instructions or medical educational content relating to a type of disease or to a pathology of a physiological system.

13. A method in accordance with claim 12,
wherein the physiological measurement of the patient comprises at least one of: weight, blood pressure, pulse rate, glucose level, an antigen level, pH, pO₂, temperature, EKG rhythm, pO2 saturation of the blood, and hormone level; and
wherein the psychological measurement comprises a score based upon one or more standardized or non-standardized tests that measure at least one of: anxiety, stress, anger, suicidal tendencies, schizophrenic relapse, rapid cycling bipolar relapse, and confusion.

14. A method in accordance with claim 12, wherein the disease state or medical condition of the patient comprises at least one of:
congestive heart failure, hypertension, angina, circulatory inadequacy or other disease condition of the cardiopulmonary and circulatory systems, specific organ failure, dysfunction of an organ or system or transplanted organ, including asthma for the lungs, kidney failure for the kidney, arteriosclerosis or atherosclerosis of the heart, and transplantation of lung, kidney or heart;
wherein the bacterial disease agent comprises a bacterial agent for at least one of: tuberculosis, malaria, cholera, and meningitis, and
wherein the microbial agent comprises a virus, a bacteria, a microbial agent for mycotic infection, and a microbial agent for parasitic infection;
wherein the type of disease comprises cancer and autoimmune disease; and wherein the pathology of the physiological system comprises a pathology of the muscular-skeletal, hematopoetic, circulatory, reproductive, dermatologic, digestive, endocrine or nervous systems.

15. A method in accordance with claim 1, wherein the report indicates whether the patient is stable, better or worse.

16. A system for monitoring the effect of a medication on one or more patients, the system comprising:
a database configured to store therein a plurality of data elements representative of a medical treatment plan for treating the patients with the medication, the database being linked through a communications network to at least one remote monitoring device configured for use by the patients; and
a controller for controlling access to the database and for controlling communications over the network;
wherein the controller is configured to transform the data elements into a sequence of prompt and record events, and to cause the sequence of events to be communicated to the remote monitoring device over the network;
wherein the controller is further configured to receive patient response data supplied by the patients in response to the sequence of events, and to upload the patient response data onto the database; and
wherein the controller is further configured to correlate the patient response data with additional data relating to one or more patient outcomes; and
means for providing a report of said correlation for a selected range of dates comprising one or more days.

17. A method system in accordance with claim 16, wherein the report relates to data for an individual patient.

18. A method in accordance with claim 16, wherein the report relates to data for a group of patients.

19. A method in accordance with claim 16, wherein the report includes patient response data that is correlated with additional data relating to one or more patient outcomes, to determine the relationship between the medication intake by the patient and the patient outcomes.

20. A method in accordance with claim 16, wherein the act of correlating the patient data with additional data comprises:
combining the patient data with the additional data and
performing data mining and statistical analysis of the combined data; and providing a report of said analysis.

21. A system in accordance with claim 16, wherein the controller is further configured to adjust one or more recommended dosing instructions for the medication, using the correlation between the patient response data and the additional data.

22. A system in accordance with claim 16, wherein the patient response data provide information relating to at least one of:
patients' compliance to intake of the medication;
patients' answers to one or more health status questions;
patients' answers to one or more quality of life questionnaires;
patients'physiologic data; and
patients' laboratory data.

23. A system in accordance with claim 16, wherein the additional data comprise at least one of:
patient genomic data, patient proteomic data, patient phenotypic data, patient economic data, and patient healthcare data; and
wherein the additional data relate to at least one of:
a medication side effect;
patients' health status;
patients' quality of life;
patients' physiologic status:
patients' genotype;
a resulting value of a laboratory test performed on one or more patients;
a serum protein;
a cell surface receptor;
an economic cost of medication treatment; and
an interaction between two or more drugs.

24. A system in accordance with claim 16, wherein the data elements stored in the database relate to at least one of:
instructions relating to the medication;
medical educational content regarding the medication;
intake dosage for the medication;
physiological measurement of one or more patients;
one or more cell surface receptors;
one or more serum proteins;
DNA data;
protein data;
psychological measurement of one or more patients,
instructions or medical education content related to a disease state or a medical condition of one or more patients;
a pathogen or a class of pathogen:
instructions or medical educational content related to a viral infection, or upon a specific viral disease such as HIV/AIDS, hepatitis A, B, C, D, E or G;
instructions or medical educational relating to one of a bacterial disease agent and a microbial agent; and
instructions or medical educational content relating to a type of disease or to a pathology of a physiological system.

25. A system in accordance with claim 16, further comprising a user interface configured to provide user access to the database for one or more users.

26. A system in accordance with claim 16, further comprising a security module configured to perform a security check on at least one of:
data that is input into the database;
data that is output from the database; and
users that seek to access the database.

27. A machine-readable medium having stored therein instructions that, when executed by a computer, cause the computer to:
create a medical treatment plan for treating a patient with a medication and store the medical treatment plan as a plurality of data elements in a database that is linked through a communications network to at least one remote monitoring device configured for use by the patient;
transform the data elements into a sequence of prompt and record events;
communicate the sequence of events to the patient over the network, and obtain patient response data supplied by the patient in response to the sequence of events, the patient response data relating at least in part to a record of an intake of the medication by the patient;
upload the patient response data onto the database; and
correlate the patient response data with additional data relating to one or more patient outcomes, to determine the relationship between the intake of the medication and the patient outcomes; and
provide a report of said patient response data for a selected range of dates comprising one or more days.

28. A computer system for monitoring the effect of a medication on a patient, the system comprising:
means for creating a medical treatment plan for treating the patient with the medication, wherein the medical treatment plan is defined as a plurality of data elements representing one or more configuration files for the patient;
means for storing the plurality of data elements;
means for translating the data elements into a sequence of prompt and record events;
means for communicating the sequence of events over a network to a remote monitoring device usable by the patient;
means for obtaining patient response data supplied by the patient in response to the data elements, and for uploading the patient response data onto the database, the patient response data relating at least in part to a record to the intake of the medication by the patient; and
means for correlating the patient response data with additional data relating to one or more patient outcomes; and
means for providing a report of said patient response data for a selected range of dates comprising one or more days.

29. (canceled)

30. (canceled)

31. A system in accordance with claim 16, wherein the controller is further configured to adjust the recommended dosing instructions for the medication, based on the correlation between the patient response data and the additional data.

32. (canceled)

33. A system in accordance with claim 16, wherein the controller is further configured to adjust the recommended dosing instructions for the medication for a specific population of patients, based upon one or more characteristics shared by said population of patients, and based on the correlation between the patient response data and the additional data, so as to reduce the likelihood of medication side effects in said population, and so as to reduce the likelihood of drug interactions between two or more drugs.
